(19) United States
(12) Patent Application Publication
(10) Pub. No.: US 2026/0366172 A1
(43) Pub. Date: Nov. 19, 2026

(54) METHOD AND PROCESS FOR ELECTROCHEMICAL OXIDATION

(71) Applicant: ECOX GLOBAL PTE LTD, Singapore (SG)

(72) Inventor: Alejandro MONTOYA, Sydney, NSW (AU)

(21) Appl. No.: 19/133,555

(22) PCT Filed: Nov. 29, 2023
(86) PCT No.: PCT/IB2023/062000

§ 371 Date: May 28, 2025

(30) Foreign Application Priority Data
Nov. 29, 2022 (AU) 2022903618

(51) Int. Cl. C25B 1/29; C22B 3/00; C22B 3/06; C22B 7/00; C22B 15/00; C22B 34/22; C22B 34/32; C22B 47/00; C25B 9/19; C25B 11/043; C25B 15/08

(52) U.S. Cl. CPC C25B 1/29; C22B 3/06; C22B 7/007; C22B 15/0067; C22B 23/0415; C22B 34/22; C22B 34/32; C22B 47/00; C25B 9/19; C25B 11/043; C25B 15/081

(57) ABSTRACT

The invention relates to a method and system for generation of an oxidant solution including an electrochemical cell having an anode and a cathode, the method comprising the steps of; (i) supplying a feedstock electrolyte to a reaction area between the anode and cathode, the feedstock electrolyte consisting of sulphate ions (SO₄²⁻) and ferrous ions (Fe²⁺); (ii) in an operational cycle, electrolysing the feedstock electrolyte to produce an oxidised acid solution comprising peroxydisulphate (S₂O₈²⁻) and ferric ions (Fe³⁺); and (iii) supplying said oxidised acid solution. The oxidant solution is preferably used for leaching metals from waste, including e-waste and metal containing ores.

### FIELD OF INVENTION

The present invention relates to the field of electrochemistry.

In one form, the invention relates to production of an oxidant solution using an electrochemical cell.

In one particular aspect the present invention is suitable for use in metal extraction, such as metal extraction from a solid or solid particulate waste such as mining ore, or a source of e-waste.

In another particular aspect the invention is suitable for use in a metal leaching process, or alternatively an electrowinning process.

It will be convenient to hereinafter describe the invention in relation to e-waste, particularly e-waste that includes copper, however it should be appreciated that the present invention is not limited to that use only and can be applied to other feedstocks or waste streams that include one or more other metals or metal ions, such as those generated by the mining industry.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Many feedstocks and waste streams include at least one metal compound. These include ores, landfill residues, sludges, tailings, slags, ashes, filter dust from incinerators, blanks or e-waste, and wafers from electronic circuits. E-waste is defined as a waste generated from wide range of electronic devices such as computers, mobile phones, televisions, and household appliances.

E-waste is of growing concern because it is being generated in increasing quantities due to rapid advancements in technology and increasing consumer demand for electronic goods. Many countries have introduced legislation and policies for management of e-waste. For example, in 2011, Australia implemented the national television and computer recycling scheme (NTCRS). The objective of the NTCRS is to achieve 80% e-waste recycling by 2030 and provide households, and small businesses with access to industry-funded e-waste recycling to dispose of used electronic equipment. The implementation of this type of recycling initiative offers the opportunity to extract and recycle valuable metals.

The metal can be recovered from waste streams by electrochemical means using oxidised acid. In such a process, oxidised acid may be produced by oxidising a starting acid at the anode of the electrochemical cell, then rinsing or submerging the starting material with the oxidised acid to dissolve metal or metal compounds, and finally depositing the dissolved metal at a cathode of the electrochemical cell.

Electrochemistry utilises a flow of electrons to drive oxidation and reduction reactions. Electrochemical cells typically include two half cells, one half cell associated with an anode (positive electrode), the other half cell associate with the cathode (negative electrode) with an electrolyte therebetween to facilitate reaction and movement of ions.

In electrochemical cells, oxidation of metals occurs at the anode and reduction of metal occurs at the anode in a so-called ‘redox’ reaction. Redox reactions happen when an oxidising agent is present, usually in the electrolyte, to oxidise another substance by taking electrons and being reduced. Oxidised acids are particularly useful in the electrolyte used in electrochemical reactions because they can often oxidise metals that are less reactive to other acids.

For example, German patent no. 10 2015 110 179 (DE 10 2015 110 179) describes the use of oxidised acids and diamond doped cathodes in an electrochemical cell for extraction of metal from solid feedstock. The method has been successfully tested on the solutions of filter dust containing Zn, Cu, Fe, Ni and Sn, Chilean copper slag (CuFe), chalcopyrite (CuFeS2) and copper orifice.

According to DE 10 2015 110 179, using oxidised acids such as peroxydisulphates provides a substantial increase in the amount of metal brought into solution compared with other acids, in many cases at least doubling the solution of the metal. DE 10 2015 110 179 also asserts that neither process parameters nor the concentration of the oxidised acids is critical and that a concentration of at least 0.1 mol/l, preferably at least 0.5 mol/l and further preferably at least 1 mol/l of the oxidised acid, should be present. Concentrations beyond this are not critical.

The use of oxidised acids such as peroxydisulphates is also discussed in U.S. Pat. Nos. 10,259,727 and 10,046,898 to Advanced Diamond Technologies in an electrochemical system for water disinfection and removal of organics. Operation at high current density using a diamond anode (and optionally a diamond cathode) is claimed to provide high current efficiency, extended lifetime operation and improved cost efficiency.

### SUMMARY OF INVENTION

An object of the present invention is to enable a more efficient method for electrochemical generation of an oxidising anolyte solution.

Another object of the present invention is to improve the economic aspects of the process of using an oxidising anolyte solution to extract metal, including improving the metal extraction and reducing energy consumption of the process.

Another object of the present invention is to provide a more effective oxidising anolyte solution for extraction of metal or metal ions from a feedstock or waste stream.

Yet another object of the present invention is to provide an electrochemical process that can regenerate and reuse key electrolytic ions.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a broad sense the invention relates to a method for electrochemical generation of an anolyte solution comprising peroxydisulphate (S₂O₈²⁻) and ferric ions (Fe³⁺) from an electrolyte feedstock comprising sulphate ions (SO₄²⁻) and ferrous ions (Fe²⁺).

In a first aspect of embodiments described herein there is provided a method for generation of an oxidant solution using an electrochemical cell having an anode and a cathode, the method comprising the steps of:
(i) supplying a feedstock electrolyte to a reaction area between the anode and cathode, the feedstock electrolyte consisting of sulphate ions (SO₄²⁻) and ferrous ions (Fe²⁺);
(ii) in an operational cycle, electrolysing the feedstock electrolyte to produce an oxidised acid solution comprising peroxydisulphate (S₂O₈²⁻) and ferric ions (Fe³⁺); and
(iii) supplying said oxidised acid solution.

In a second aspect of embodiments described herein there is provided a method for generation of an oxidant solution using an electrochemical cell having an anodic half-cell and a cathodic half-cell, the method comprising the steps of:
(i) supplying to the anodic half-cell, a feedstock electrolyte to enter and exit a fluid path formed between the anode and cathode, the feedstock electrolyte consisting of sulphate ions (SO₄²⁻) and ferrous ions (Fe²⁺);
(ii) in an operational cycle, electrolysing the feedstock electrolyte to produce an anolyte solution comprising peroxydisulphate (S₂O₈²⁻) and ferric ions (Fe³⁺); and
(iii) supplying said anolyte solution from the anodic half-cell.

Typically, the anodic half-cell and cathodic half-cell are separated by a separator, such as a porous film or ion-exchange membrane. In a preferred embodiment the ion-exchange membrane is a cation exchange membrane or an anion exchange membrane, more preferably a monovalent selective anion membrane The use of a separator advantageously allows the oxidising power of the acid to be increased. Where used herein the term ‘divided cell’ configuration refers to a configuration wherein a separator is inserted to separate the anode and cathode.

In another embodiment the anodic half-cell and cathodic half-cells may be combined, such as by removing the separator to form a single electrochemical cell, so that the anolyte solution is supplied as the electrolyte for the electrochemical cell. Where used herein the term ‘undivided cell’ configuration refers to a configuration in which there is no separator or other barrier between anode and cathode.

The operational cycle of the method may comprise a single pass or it may be operated in recycle mode. The operational cycle may comprise electrolysing the electrolyte in a single batch or a continuous flow system. Recycling and electrolysing a batch volume of electrolyte can be used to increase the concentration of oxidant converted from the feedstock.

In one embodiment the anolyte solution from the chemical cell may be provided to a downstream process such as an electrowinning cell. In another embodiment the anolyte solution may be generated and supplied on-site and fed directly into a process for hydrometallurgy and leaching metal from or deposits, mines, mining dumps, and landfills. For example, the anolyte may be generated at a mine site and pumped into a mine borehole, forced along the length borehole and then back to the surface, where the separation of metal from the anolyte can take place. In another embodiment, the anolyte solution may be generated and supplied on-site to replace leaching solutions in common hydrometallurgical processes such as heap leaching and multiple variations of tank and vat leaching.

The use of aqueous chemistry for the recovery of metals from ores, concentrates and recycled or residual materials is known as hydrometallurgy. Hydrometallurgy is a more economical and environmentally friendly alternative to metallurgical methods. It has shown advantages in processing low-grade ores and mainly includes heap leaching, in-situ leaching and tank leaching. However, hydrometallurgical processes have not been widely used in some sulphide ore processing, such as chalcopyrite, due to the slow dissolution rate in acid, which is mainly due to the formation of polysulfide (Sn²⁻) and elemental sulphur (S₀) passivation layer. Therefore, researchers speed up leaching efficiency by adding various oxidants including Fe³⁺, O₂, H₂O₂, Cr₂O₇²⁻, ClO₄⁻, O₃, MnO₄⁻ and S₂O₈⁻. In prior art it was concluded that the dissolution kinetics of chalcopyrite, when interacting with non-radical oxidants such as H₂O₂, predominantly follow a shrinking core model, with surface chemical reactions being the rate-determining step. Therefore, the addition of a significant amount of oxidant in the reaction system during heap leaching is necessary to maintain high leaching efficiency and compensate for the consumption and deactivation of the oxidant.

In another embodiment the anolyte solution from the chemical cell may be used in a process for leaching and selective recovery of metals from e-waste including base metals such as Cu, Ni, Fe, precious metals such as Au, Ag, platinum based metals such as Pt, Pd, Rh, Ir and Ru, scarce metals such as Te, Ga, Se, Ta and Ge and hazardous metals such as Pb, Cd, In, Sb. In a particularly preferred embodiment, the metals extracted from e-waste are Cu, Ni, Zn and Al.

Typically, the concentration of sulphate ions (SO₄²⁻) in the feedstock electrolyte is between 0.1 molar and 5 molar.

Typically, the sulphate ions (SO₄²⁻) would be provided from a feedstock of sulphuric acid (H₂SO₄²⁻). The present invention uses a low acid concentration, as compared with equivalent processes of the prior art that use acid of 15 to 20 molar. The lower acid concentration lowers the cost of feedstock and improves the safety of the process.

Typically, the concentration of ferrous ions (Fe²⁺) is between 0.1 and 0.5 molar.

Typically, the aqueous feedstock electrolyte is electrolysed at a current density from about 50 to 200 mA/cm⁻².

Preferably the ratio of SO₄²⁻:Fe²⁺ is between 1:0.05 and 1:0.5, more preferably between 1:0.05 and 1:0.1.

Typically, the anode is a doped diamond electrode, such as boron-doped diamond electrode. However, other electrode materials such as carbon composite materials, stainless steel, copper or titanium are also suitable.

Typically, the cathode is a doped diamond electrode. However, other electrode materials such as carbon composite materials, stainless steel, copper or titanium are also suitable.

The methods described above may also include regeneration and reuse key electrolytic ions. For example, in an operational cycle, the feedstock electrolyte consisting of sulphate ions (SO₄²⁻) and ferrous ions (Fe²⁺), may be used to produce an anolyte solution comprising peroxydisulphate (S₂O₈²⁻) and ferric ions (Fe³⁺). The ferric ions (Fe³⁺) are used to leach out a metal from waste and as a result are converted to ferrous ions (Fe²⁺). The ferrous ions (Fe²⁺) react with peroxydisulphate (S₂O₈²⁻), which is converted to sulphate ions (SO₄²⁻) and ferric ions (Fe³⁺), thus completing regeneration of the ions from the feedstock electrolyte.

In a third aspect of embodiments described herein there is a method for regeneration of the aforementioned oxidant solution including the further steps of:
(iii) supplying said oxidised acid solution to a metal containing waste, such that the ferric ions (Fe³⁺) are reduced to ferrous ions (Fe²⁺);
(iv) bringing peroxydisulphate (S₂O₈²⁻) into contact with the ferrous ions (Fe²⁺) to regenerate ferric ions (Fe³⁺) and sulphate ions (SO₄²⁻).

Again, the regeneration can be carried out with or without a separator between the anodic half-cell and cathodic half-cell.

In a fourth aspect of embodiments described herein there is provided a system for generation of an oxidant solution, comprising:
(a) an anode and a cathode defining a reaction area of an electrochemical cell;
(b) an input port and flow controller for passage of aqueous feedstock electrolyte between the electrodes, the feedstock electrolyte consisting of sulphate ions (SO₄²⁻) and ferrous ions (Fe²⁺), the sulphate ions and ferrous ions being selected for electrochemical generation of an oxidant comprising peroxydisulphate (S₂O₈²⁻) and ferric ions (Fe³⁺);
(c) current means for supplying current for electrolysing the aqueous feedstock electrolyte to produce an oxidant solution in the reaction area containing said oxidant; and
(d) an output port for supplying the oxidant solution from the electrochemical cell.

The oxidant solution may be suitable, for example, for extraction of metal from e-waste or minerals, including waste streams associated with mineral processing.

In a fifth aspect of embodiments described herein there is provided a system for on-site generation of an oxidant solution for metal extraction, comprising:
(a) an anodic half-cell and a cathodic half-cell;
(b) an input port and flow control means for passage of aqueous feedstock electrolyte through the anodic half-cell, the feedstock electrolyte consisting of sulphate ions (SO₄²⁻) and ferrous ions (Fe²⁺), the sulphate ions and ferrous ions being selected for electrochemical generation of an oxidant comprising peroxydisulphate (S₂O₈²⁻) and ferric ions (Fe³⁺);
(c) current means for supplying current for electrolysing the aqueous feedstock electrolyte to produce an oxidant solution in the anodic half-cell containing said oxidant; and
(d) an output port for supplying the oxidant solution from the electrochemical cell from the anodic half-cell.

Oxidant solution generated on-site may be suitable, for example, for extraction of metal from e-waste or minerals, including waste streams associated with mineral processing.

In another aspect of embodiments described herein there is provided a method of leaching metal from metal containing waste, the method including the step of providing the oxidant solution of the present invention and bringing the oxidant solution into contact with the metal containing waste.

The metal leached from the metal containing waste typically includes copper.

Other aspects and preferred forms are disclosed in the specification and/or defined in the appended claims, forming a part of the description of the invention.

In essence, embodiments of the present invention stem from the realisation that the presence of ferrous ions (Fe²⁺) can substantially improve the production of an oxidant solution using an electrochemical cell. Furthermore, there is also the realisation that the combination of ferrous ions (Fe²⁺) in combination with sulphate ions (SO₄²⁻), for electrochemical generation of an oxidant comprising peroxydisulphate (S₂O₈²⁻) and ferric ions (Fe³⁺), provides a superior oxidant for extraction of metals. It has also been realised that advantageously, it is also possible to regenerate the oxidiser and the acid (peroxydisulphate (S₂O₈²⁻) and ferric ions (Fe³⁺)) during multiple operational cycles.

Advantages provided by the present invention comprise the following:
improved electrochemical cell efficiency in terms of power consumption;
improved electrochemical cell efficiency in economic terms;
the oxidiser/acid can be regenerated during multiple operational cycles of an electrochemical cell thus lowering operational costs and reducing waste;
low acid concentrations can be used, as compared with the prior art, thus lowering the cost of feedstock and improving the process safety;
complete extraction of certain metals may be achieved in a relatively short period of time.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates a typical electrochemical cell;

FIG. 2 illustrates a reactor apparatus including an electrochemical cell having a membrane separating the anodic half-cell from the cathodic half-cell;

FIG. 3A illustrates an electrochemical cell of the type used in the present invention;

FIG. 3 is a plot of the concentration of peroxydisulphate ions (S₂O₈²⁻) against time derived using the electrochemical cell shown in FIG. 3A;

FIG. 4A illustrates an electrochemical cell of the type used in the present invention;

FIG. 4B is a plot of the conversion of ferrous ions (Fe²⁺) to ferric ions (Fe³⁺) against time in the cell of FIG. 4A;

FIG. 5 illustrates an electrochemical cell for in-situ copper extraction according to the present invention;

FIG. 6A and FIG. 6B are plots illustrating the extent of copper conversion in the electrochemical cell of FIG. 5;

FIG. 7 is a plot of copper conversion against reaction time for the electrochemical cell of FIG. 5;

FIG. 8 is a plot of iron composition (Fe²⁺/Fe³⁺) against reaction time measured using the electrochemical cell of FIG. 5;

FIG. 9 is a plot of power consumption against different compositions of leaching medium measured using the electrochemical cell of FIG. 5;

FIG. 10 is a plot of power consumption against reaction time, measured using the electrochemical cell of FIG. 5;

FIG. 11 is a schematic diagram of an electrolyser for leaching of e-waste;

FIG. 12 is a schematic diagram of a pilot-scale electrolyser with divided cell configuration according to the present invention;

FIG. 13 is a schematic diagram of an electrodeposition reactor apparatus for metal recovery according to the present invention;

FIG. 14 is a flow chart illustrating the general concept of process development for metals leaching;

FIG. 15 is a schematic illustration of oxidiser production (Fe³⁺ and/or peroxydisulphate) and in-situ leaching of e-waste in an undivided cell;

FIG. 16 is a schematic illustration of oxidisers production (Fe³⁺ and peroxydisulphate) and leaching in a single step in a divided cell;

FIG. 17 is a profile of peroxydisulfate (peroxydisulphate) concentration at varying initial sulphate concentration and under the same reaction conditions (i.e., current density=150 mA cm−2 and flow rate=50 mL min−1);

FIG. 18A and FIG. 18B are profiles of ferric and peroxydisulfate ions at (A) 0.5 M Fe²⁺ and (B) 0.25 M of Fe²⁺ with varying initial sulphate concentration as a function of reaction time and under the same reaction conditions (i.e., current density=150 mA cm⁻² and flow rate=50 mL min⁻¹) in a divided cell configuration with an anion exchange membrane;

FIG. 19A and FIG. 19B are profiles of (A) extracted copper (wt %) and (B) mole fraction of ferric ions as a function of reaction time at varying SO₄²⁻/Fe²⁺ ratio under reaction conditions of current density=150 mA cm⁻² and flow rate=50 mL min⁻¹;

FIG. 20 is a plot of the concentration of metals extracted in a lab-scale electrolyser as a function of reaction time and under reaction conditions of SO₄²⁻/Fe²⁺=1/0.1, current density=150 mA cm⁻² and flow rate=50 mL min⁻¹;

FIG. 21 is a plot of metals extracted in a pilot-scale electrolyser as a function of reaction time. Reaction conditions: SO₄²⁻/Fe²⁺=1/0.1, current density=150 mA cm⁻² and flow rate=1 L min⁻¹;

FIG. 22 is a plot of the concentration of metals extracted in a pilot-scale electrolyser for 3 batches of e-waste loading as a function of reaction time under conditions of 2.5 M of initial sulphate concentration, current density=150 mA cm⁻² and flow rate=1 L min⁻¹;

FIG. 23 is a proposed design for a commercial electrolyser;

FIG. 24 is a plot of copper recovery as a function of reaction time;

FIG. 25 is a plot of Oxidation Reduction Potential (ORP) against time for laboratory and pilot scales electrolysers as a function of reaction time under reaction conditions of SO₄²⁻/Fe²⁺=1/0.1, current density=150 mA cm⁻²,

FIG. 26 is a plot of ORP against time for a pilot-scale electrolyser for 3 batches of e-waste loading as a function of reaction time under conditions of 2.5 M of initial sulphate concentration, current density=150 mA cm⁻² and flow rate=1 L min⁻¹;

FIG. 27 is a plot of copper recovery from chalcopyrite as a function of time and temperature for a lab scale reactor under conditions SO₄²⁻/Fe²⁺=1/0.1, current density=100 mA cm⁻² and 700 RPM;

FIG. 28 is a plot of copper recovery from chalcopyrite as a function of time and depicting the effect of mixing at 700 rpm with and without ultrasound under the conditions SO₄²⁻/Fe²⁺=1/0.1, current density=100 mA cm⁻² and 700 RPM;

FIG. 29 is a plot of the effect of stirring speed on copper recovery from chalcopyrite under the conditions SO₄²⁻/Fe²⁺=1/0.1, current density=100 mA cm⁻²;

FIG. 30 is a plot of the concentration of metals extracted in a lab scale electrolyser for a batch of Nickel Ore 1 as a function of reaction time under conditions of 2.5 M of initial sulphate concentration, SO₄²⁻/Fe²⁺=1/0.1, current density=150 mA cm⁻² and flow rate=50 mL min⁻¹;

FIG. 31 is a plot of the concentration of metals extracted in a lab scale electrolyser for a batch of Nickel Ore 2 as a function of reaction time under conditions of 2.5 M of initial sulphate concentration, SO₄²⁻/Fe²⁺=1/0.1, current density=150 mA cm⁻² and flow rate=50 mL min⁻¹;

FIG. 32 shows the metal recovery improvement after 2 hours of treatment in the electrolyser using the anolyte solution with respect to standard acid leaching with 2.5M H₂SO₄. Electrolyser conditions are 2.5 M of initial sulphate concentration, SO₄²⁻/Fe²⁺=1/0.1, current density=150 mA cm⁻² and flow rate=50 mL min⁻¹;

FIG. 33 is a simplified flow diagram depicting a standard heap leaching process;

FIG. 34 is a simplified schematic of the Shanks System;

FIG. 35 is a diagram of a Rotocel Extractor in front view (FIG. 35A) and top view (FIG. 35B).

### DETAILED DESCRIPTION

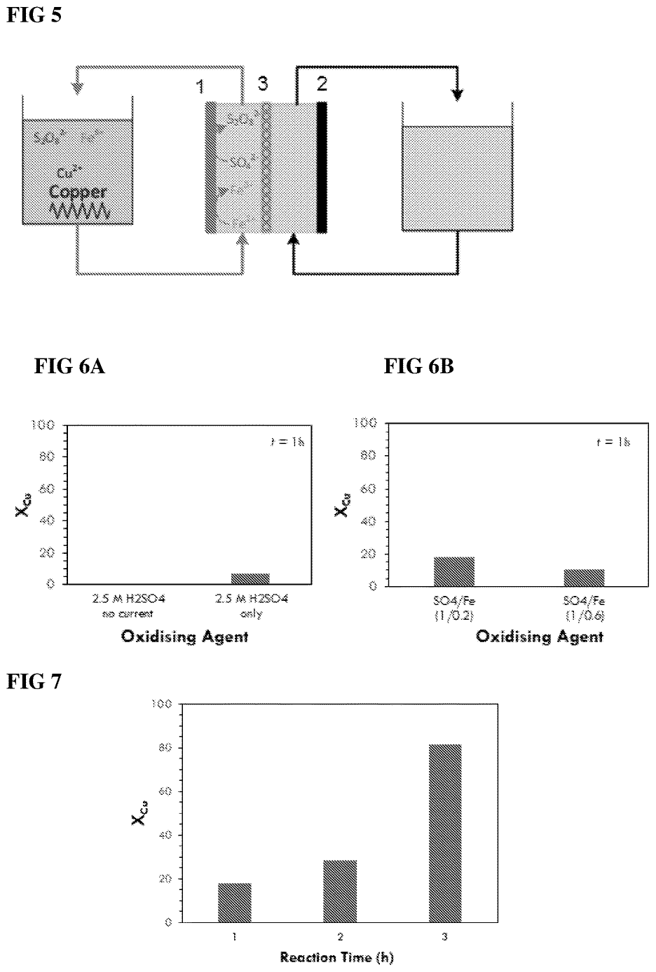

For purposes of description herein, the terms “upper,” “lower,” “right,” “left,” “rear,” “front,” “vertical,” “horizontal,” “interior,” “exterior,” and derivatives thereof shall relate to the invention as oriented in FIG. 5. However, it is to be understood that the invention may assume various alternative orientations, except where expressly specified to the contrary. It is also to be understood that the specific devices and processes illustrated in the attached drawing and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

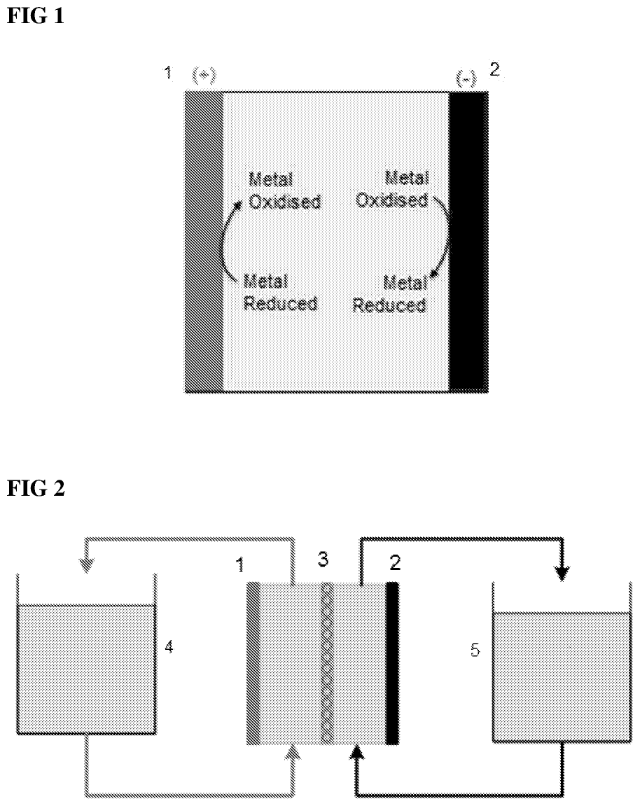

FIG. 1 illustrates a typical electrochemical cell comprising two half cells, one half cell associated with an anode (1) (positive electrode), the other half cell associate with the cathode (2) (negative electrode) and an electrolyte therebetween. In the relevant redox reaction metal is oxidised at the anode, and oxidised metal is reduced at the cathode. Redox reactions happen when an oxidising agent is present, usually in the electrolyte, to oxidise another substance by taking electrons and being reduced.

FIG. 2 illustrates an electrochemical cell that includes a membrane (3) that allows only negatively charged ions to migrate from the anode (1) to the cathode (2). Positively charged ions remain on the anolyte side of the membrane.

Oxidised acids are often included in the electrolyte of an electrochemical cell because they can oxidise some metals that are less reactive to other acids. The present invention is concerned with the electrochemical generation of an anolyte solution comprising peroxydisulphate (S₂O₈²⁻) and ferric ions (Fe³⁺) from an electrolyte feedstock comprising sulphate ions (SO₄²⁻) and ferrous ions (Fe²⁺). Peroxydisulfate ions (S₂O₈²⁻) have strong oxidising capabilities—attributed to their ability to generate sulfate radicals (SO₄^{·-}). Metal chemical dissolution by peroxydisulfate ion is also known as oxidative dissolution or leaching of metals and involves the process of dissolving metals in a solution by utilising peroxydisulfate as an oxidising agent. As a result of this dissolution, the metal dissolved will be involved in activating the peroxydisulfate ion, to generate a sulfate radical. This offers an environmentally friendly alternative to traditional leaching agents like cyanide and sulfuric acid, which pose significant environmental risks.

Preferably, the oxidant solution is generated using an electrochemical cell having an anodic half-cell and a cathodic half-cell. A feedstock electrolyte is passed between the anode and cathode. If a porous membrane is used, the feedstock electrolyte is passed through the anodic half-cell. The feedstock electrolyte consisting of sulphate ions (SO₄²⁻) and ferrous ions (Fe²⁺) which during an operational cycle of the electrochemical cell is oxidised to produce an oxidised acid solution comprising peroxydisulphate (S₂O₈²⁻) and ferric ions (Fe³⁺).

The oxidised acid solution from the electrochemical cell can be formed in the reaction area between the anode or cathode. Alternatively, when the anodic half-cell and cathodic half-cell are separated by a separator, such as a porous film or ion-exchange membrane, the oxidised acid solution can be formed in the anodic half-cell. A reservoir in fluid communication with the anodic half-cell may be used for circulating or storing the anolyte solution.

The operational cycle of the electrochemical cell may comprise recycling and electrolysing a batch volume of electrolyte to increase the concentration of oxidant converted from the feedstock.

### Metal Containing Waste

The operational cycle of the electrochemical cell may comprise electrolysing waste containing metal in a single pass or a continuous flow system Dissolved metals can be separated by deposition at the cathode and the acid can be regenerated by re-oxidation at the anode, thus allowing the process to be operated in a single pass. Alternatively, the process can be operated continuously if the leached waste material can be removed from the reaction area, new waste material can be fed in.

The process can be used to leach metals from liquids, solutions or solid materials, such as circuit boards or wafers, and deposit them at the cathode. The metal deposited on the cathode can be readily removed from the cathode by a range of known physical methods. Alternatively, electrochemical means may be employed to bring the deposited metal back into solution and re-deposit the metal in pure form on another cathode.

For example, oxidised acid solution from the chemical cell may be provided to a downstream process for extracting valuable metal from e-waste. E-waste typically comprises 40% metals, 30% ceramics (silica, alumina, alkali-earth oxides) and 30% plastic materials (polyethylene, polypropylene, polyvinylchloride, polystyrene, epoxy, nylon, etc.). These metals can be further classified into several categories, including base metals (Cu, Ni, Fe), precious metals (Au, Ag), platinum based metals (Pt, Pd, Rh, Ir and Ru), scarce metals (Te, Ga, Se, Ta and Ge) and hazardous metals (Pb, Cd, In, Sb).

More specifically, the most abundant element in e-waste is copper (Cu) (~32 wt %) of e-waste, whilst concentrations of other elements such as iron (Fe), aluminium (Al), Tin (Sn), zinc (Zn) are 13, 5.7, 1.9 and 1.7 wt %, respectively.

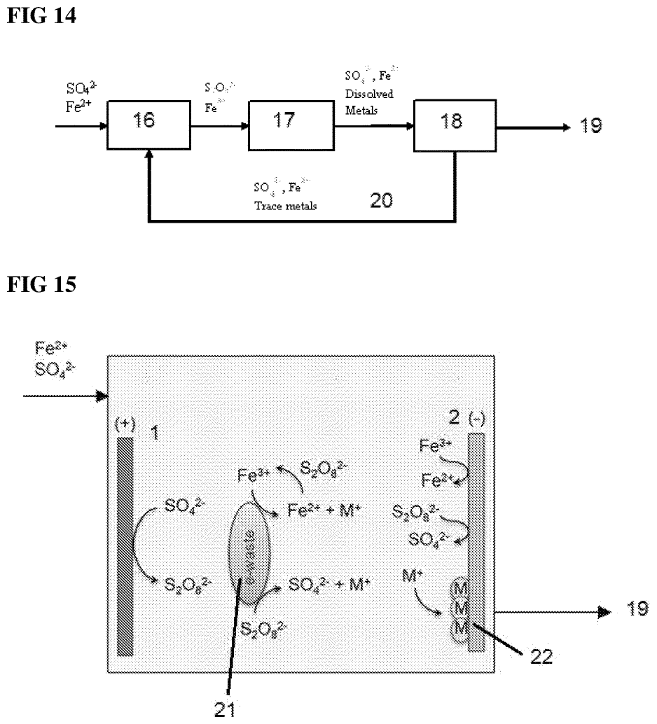

The general concept of metal recovery from e-waste is depicted in FIG. 14. The present invention aims to integrate the production of oxidisers with the leaching and selective recovery of metals from e-waste, followed by the regeneration of oxidisers from spent solution. The different steps in this process could be either unified in a single operation or separated in a sequence of unit operations.

In another process, the oxidised acid solution from the chemical cell may be provided to a downstream process such as an electrowinning cell. In another embodiment the oxidised acid solution may be generated and supplied on-site and fed directly into a process for leaching metal from ore deposits, mines, mining dumps, and landfills. For example, the oxidised acid solution may be generated at a mine site and pumped into a mine borehole, forced along the length borehole and then back to the surface, where the separation of metal from the anolyte can take place.

The use of electrochemical oxidation (EO) to generate oxidants in-situ within reaction systems becomes a sustainable and promising approach due to the rise of renewable energy technologies driving down electricity costs. The indirect oxidation process is widely considered to be the main mechanism for electrolysing ores. Therefore, producing oxidant in the reaction system is the key step for electro-oxidation of ore.

OER is a competing reaction in prior art slurry electrolysis processes, with a side effect of reducing current efficiency. It is obvious that electrodes with low OER overpotential (high OER catalytic activity), such as IrO₂, RuO₂ and platinum, produce strongly absorbed radical species, resulting in subsequently O₂ formation and lowering the oxidation ability of ROS. In contrast, electrodes with high OER overpotential (low OER catalytic activity), such as SnO₂, PbO₂ and BDD, are beneficial for inhibition of the production of O₂. Concurrently, weakly adsorbed ROS exhibit stronger oxidation capabilities, making it an ideal choice for electrolytic slurries. BDD anodes have attracted increasing attention in the electrochemical oxidation process due to their distinct properties, such as an extremely wide potential window, strong anti-corrosion stability, high energy efficiency, an inert surface with low adsorption properties, and a wide working pH range.

### EXAMPLES

The present invention will be further illustrated with reference to the following non-limiting examples:

### Example 1

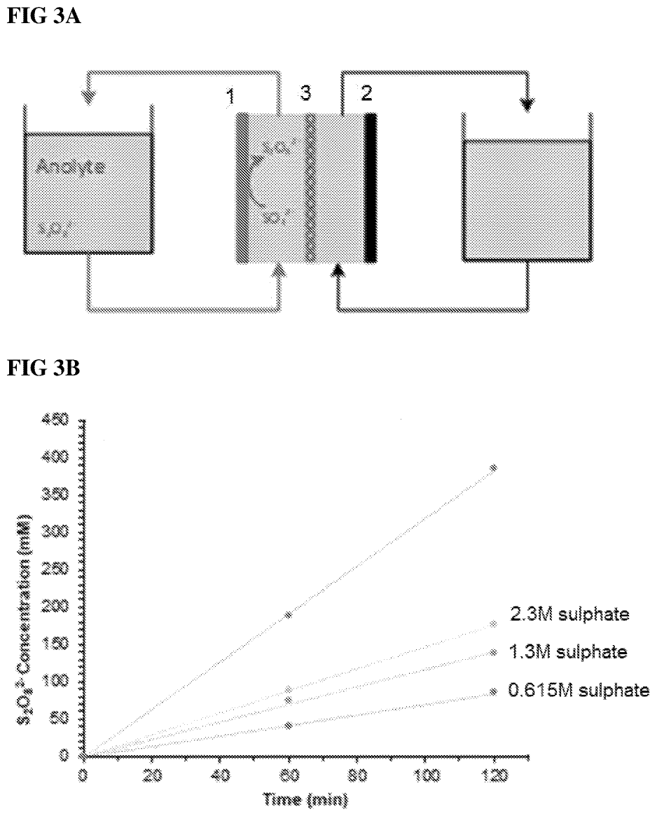

FIG. 3A illustrates an electrochemical cell of the type used in the following examples. The electrochemical cell is of 80 mL working volume. In the left-hand half-cell sulphate ions (SO₄²⁻) from sulphuric acid (H₂SO₄²⁻) in the anolyte (4) are oxidised to form peroxydisulphate ions (S₂O₈²⁻). In the right-hand half-cell the catholyte (5) includes copper ions that are reduced at the cathode and deposited as copper metal (Cu).

### Example 2

FIG. 3B is a plot of the concentration of peroxydisulphate ions (S₂O₈²⁻) against time derived using the electrochemical cell shown in FIG. 3A. Four different concentrations of sulphate ions (SO₄²⁻) were used—0.615 M, 1.3 M, 2.3 M and 5.0 M. The higher the sulphuric acid concentration, the greater the amount of peroxydisulphate ions (S₂O₈²⁻) formed in the analyte, thereby increasing the oxidative ability of the electrolyte to extract copper.

### Example 3

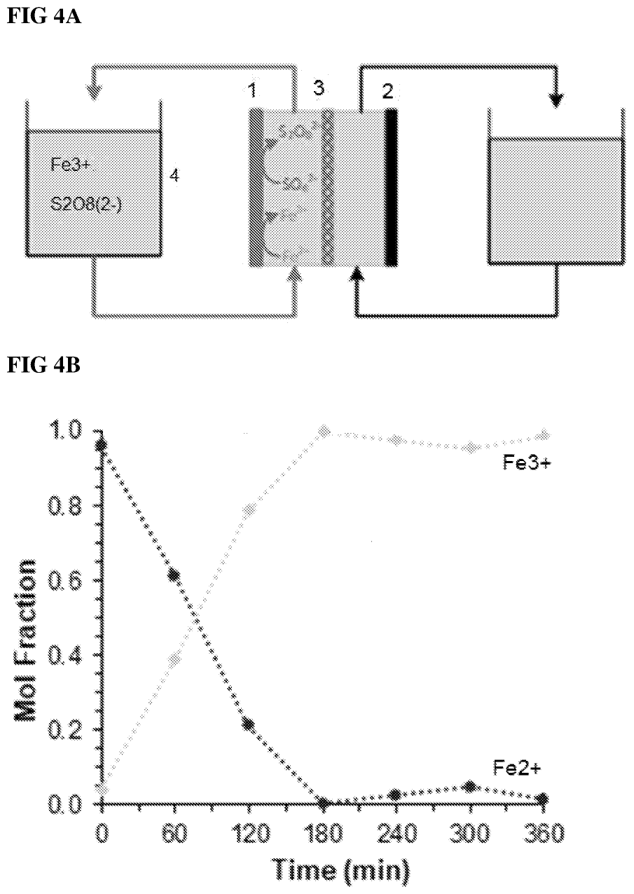

FIG. 4A illustrates an electrochemical cell of 80 mL working volume in which sulphate ions (SO₄²⁻) from 4.5M sulphuric acid (H₂SO₄²⁻) and 0.5 M ferrous sulphate (Fe₂SO₄²⁻) in the anolyte (4) are oxidised to form peroxydisulphate ions (S₂O₈²⁻) and ferric ions (Fe³⁺) in the left-hand half-cell. A separator in the form of an ion-exchange membrane facilitates the increase in the oxidising power of the acid being generated. In the right-hand half-cell the catholyte includes copper ions that are reduced at the cathode and deposited as copper metal (Cu). The current density used was 50 mA cm².

This arrangement is analogous to on-site provision of the anolyte solution from the electrochemical cell to a process for leaching metal. This would include, for example, pumping the anolyte into a mine borehole, forced along the length borehole and then back to the surface, where the separation of metal from the anolyte can take place.

FIG. 4B is a plot of the mole fraction of ferrous ions (Fe²⁺) and ferric ions (Fe³⁺) against time. The plot illustrates that peroxydisulphate ions (S₂O₈²⁻) promote the oxidation of ferrous ions (Fe²⁺) and ferric ions (Fe³⁺), the porous membrane preventing migration of the ions to the right-hand cell where it would otherwise be reduced at the cathode. The plot also indicates that an oxidative solution for metal extraction can be obtained after 3 hours of reaction time.

### Example 4

FIG. 5 illustrates an electrochemical cell for in-situ copper extraction. The cell illustrated is the same as the cell shown in FIG. 4A and includes an ion-exchange membrane (3) as a separator between the anodic half-cell and cathodic half-cell. In this embodiment of the present invention cuprous ions (Cu²⁺) were introduced into the anolyte solution (4) and reduced to copper (Cu) which was deposited in the analyte reservoir.

FIG. 5 also illustrates reactions that facilitate regeneration and reuse of key electrolytic ions. As shown, in an operational cycle, the feedstock electrolyte consisting of sulphate ions (SO₄²⁻) and ferrous ions (Fe²⁺), may be used to produce an anolyte solution comprising peroxydisulphate (S₂O₈²⁻) and ferric ions (Fe³⁺). The ferric ions (Fe³⁺) are used to leach out the cuprous ions (Cu²⁺) and as a result are converted to ferrous ions (Fe²⁺). The ferrous ions (Fe²⁺) react with peroxydisulphate (S₂O₈²⁻), which is converted to sulphate ions (SO₄²⁻) and ferric ions (Fe³⁺), thus completing regeneration of the ions from the feedstock electrolyte.

In this reaction, the reaction variables for the copper extraction can be expressed as follows:

$${X}_{Cu} = \frac{{W}_{Cu} ( 0 ) - {W}_{Cu} ( t )}{{W}_{Cu} ( 0 )} \times 100 \% \qquad Equation ( 1 )$$

X_{Cu}=Cu conversion
W_{Cu}(0)=initial weight of Cu
W_{Cu}(t)=final weight of Cu

Furthermore, the reaction variables for the power consumption can be expressed as follows:

$$P = \frac{V \cdot I \cdot t}{{W}_{Cu} ( 0 ) - {W}_{Cu} ( t )} \qquad Equation ( 2 )$$

V=Average cell voltage (Volt)
P=Power consumption (kWh/kg Cu)
I=Applied current (Amp)
t=Reaction time (h)

### Example 5

Example 5 illustrates the effect of current on an oxidising agent on copper conversion. Example 5 also illustrates the superior copper conversion achieved by the process of the present invention using both peroxydisulphate ions (S₂O₈²⁻) and ferric ions (Fe³⁺) in the anolyte, compared with the anolytes typically used in the prior art that have not used both these electrolytes.

FIG. 6A and FIG. 6B are plots illustrating the extent of copper conversion in the electrochemical cell of FIG. 5 having a working volume of 80 mL under different conditions. In all cases the sulphate ion (SO₄²⁻) concentration was 2.5 M, the current density was 150 mA cm⁻², the reaction time was 1 hour, the initial copper concentration was 3.0 g.

As a control, initially no current was passed through the cell to show there was no copper conversion. Applying current promoted the formation of oxidising agent and initiated copper extraction. FIG. 6A illustrates a small amount of copper extraction in an anolyte that includes peroxydisulphate ions (S₂O₈²⁻) alone. FIG. 6B illustrates significantly better copper extraction in an anolyte that includes both peroxydisulphate ions (S₂O₈²⁻) and ferric ions (Fe³⁺).

A ratio of 1:0.2 (sulphate ion (SO₄²⁻) to ferrous ions (Fe²⁺)) provides a better result than a ratio of 1:0.6.

### Example 6

Example 6 explored the effect of reaction time on the extent of copper conversion.

FIG. 7 is a plot of copper conversion against reaction time for the electrochemical cell of FIG. 5. The reaction included a sulphate ion (SO₄²⁻) concentration of 2.5 M, current density of 150 mA cm⁻², working volume of 80 mL and an initial 3.0 g of copper. The plot illustrates how copper conversion increases with time, reaching maximum conversion concentration (~80%) after 3 hours of reaction time.

### Example 7

Example 7 relates to the effect of reaction time on the extent of ferric ion (Fe³⁺) production.

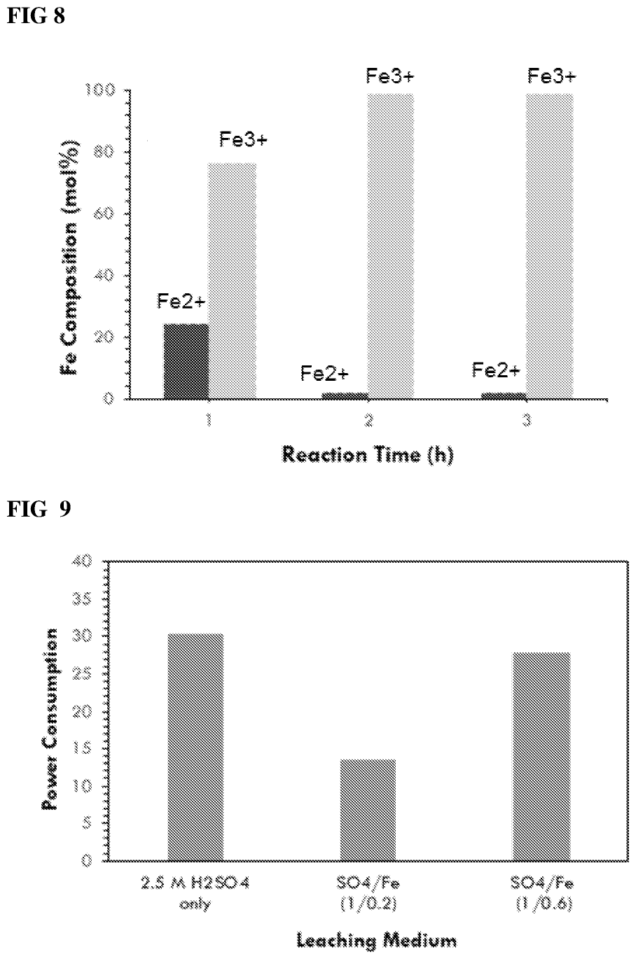

FIG. 8 is a plot of iron composition (Fe²⁺/Fe³⁺) against reaction time measured using the electrochemical cell of FIG. 5. The reaction included a sulphate ion (SO₄²⁻) concentration of 2.5 M, current density of 150 mA cm⁻², working volume of 80 mL and an initial 3.0 g of copper. Complete conversion of ferrous ions (Fe²⁺) to ferric ions (Fe³⁺) was achieved after 2 hours of reaction time. After 2 hours, copper extraction is driven by the presence of ferric ions (Fe³⁺) and peroxydisulphate ions (S₂O₈²⁻).

### Example 8

Example 8 explores the effect of current and oxidising agent on power consumption for the electrochemical cell.

FIG. 9 is a plot of power consumption against different compositions of leaching medium measured using the electrochemical cell of FIG. 5 for time (t) of 1 hour. The reaction included a sulphate ion (SO₄²⁻) concentration of 2.5 M, current density of 150 mA cm⁻², working volume of 80 mL and an initial 3.0 g of copper. The power consumption was measured for anolyte comprising 2.5M sulphuric acid (H₂SO₄) only, a mixture of 1:0.2 (sulphate ion (SO₄²⁻) to ferrous ions (Fe²⁺)) and a mixture of 1:0.6 (sulphate ion (SO₄²⁻) to ferrous ions (Fe²⁺)).

The plot illustrates that optimising the sulphate ion (SO₄²⁻) to ferrous ions (Fe²⁺) ratio is important.

### Example 9

Example 9 explores the effect of reaction time on power consumption for the electrochemical cell.

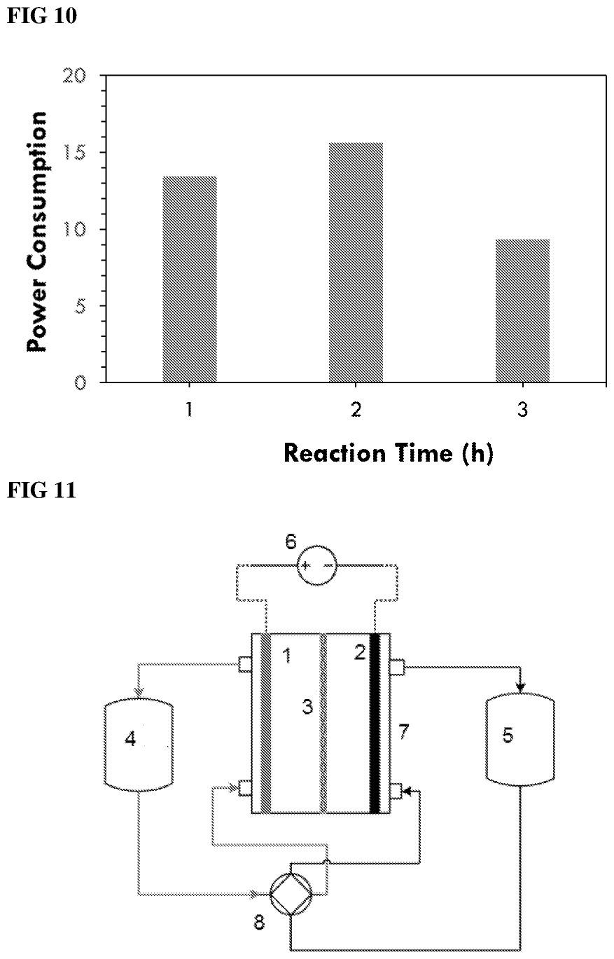

FIG. 10 is a plot of power consumption against reaction time, measured using the electrochemical cell of FIG. 5. The reaction included a sulphate ion (SO₄²⁻) concentration of 2.5 M, current density of 150 mA cm⁻², working volume of 80 mL and an initial 3.0 g of copper.

### Leaching of E-Waste

### Example 10

In this example, e-waste was collected from used computer units, primarily from CPU mainboards and desktop screens. The e-waste material was firstly shredded into small particles and sieved into a particle size of 2.7±1.2 mm (<4 mm) and then mixed with aqua regia (mixture of HNO₃ and HCl, 3:1 ratio). For a typical analysis, 0.5 g of shredded e-waste was mixed with 12 mL of aqua regia. The mixture of e-waste and aqua regia was then heated to 180 °C for 30 min in a microwave system. Under these conditions, most metals dissolved into the solution and their concentrations were measured.

Electrolyser Apparatus for Metal Leaching from e-Waste

Electrolysers for metal leaching from e-waste were built at two different scales (i.e., lab-scale and pilot-scale). The electrolysers consisted of a working electrode (anode) and counter electrode (cathode). The anode was made of BDD material, whilst a stainless steel plate was used as a cathode. Experimental metal leaching from e-waste was performed under a constant current density of 150 mA cm 2 from a DC power supply.

FIG. 11 is a schematic diagram an electrolyser according to the present invention in divided configuration. Two reservoirs (4, 5) (pre-loaded with 100 mL of solution) were used to separately recirculate the solution through anode and cathode compartments. Both reservoirs were loaded by oxidiser precursor solution (0.5-2.5 M of H₂SO₄) and e-waste sample was loaded into the anolyte reservoir (4). A constant flow rate of 50 mL min⁻¹ was delivered by a peristaltic pump (8). Each electrode surface area was 10 cm².

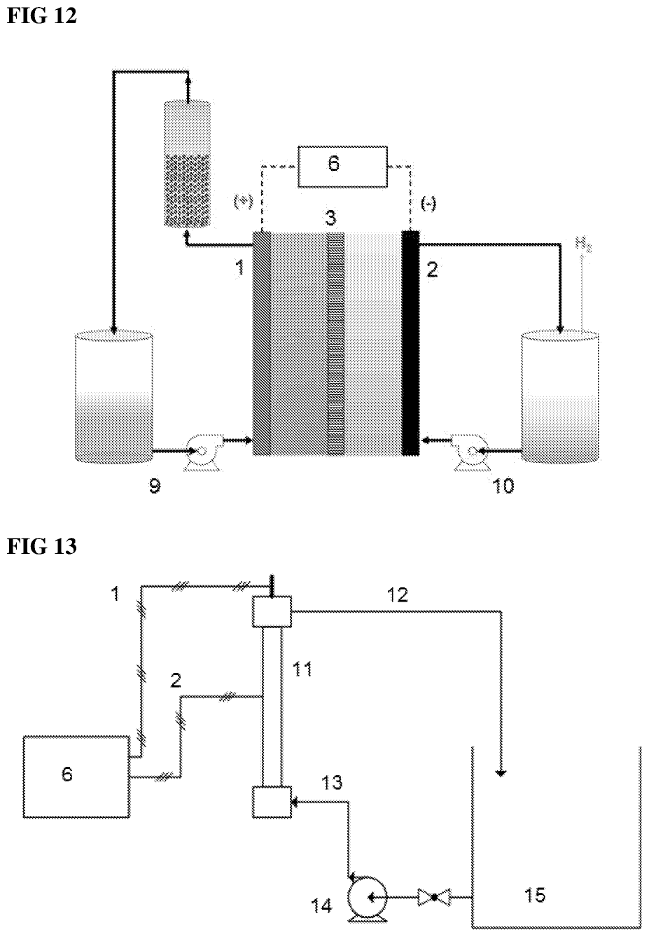

A pilot-scale electrolyser (7) as shown in FIG. 12 was utilised to evaluate metal extraction at a larger capacity and followed a similar configuration to the lab-scale electrolyser. The working electrode comprised BDD, and the counter electrode comprises stainless steel, each electrode having a surface area of 100 cm².

For a typical run, 50 g of e-waste was loaded into a vessel (denoted as a solid bed) as shown in FIG. 12. Anolyte and catholyte chambers were loaded by 1L of oxidisers precursor solution (e.g. sulfuric acid and ferrous ion). The outlet of anolyte stream which contains oxidisers was connected to the bottom of the solid bed, passing through the bed and then recirculating back to the anolyte reservoir.

The solution containing leached metal from the pilot-scale electrolyser was further treated via electrodeposition process to recover metal. The apparatus for metal recovery is shown in FIG. 13. The solution was recirculated through the electrolyser. The dissolved metals were electrodeposited in an annular cell (11) comprising an anode rod installed in the centre of the electrolyser and a cathode sheet having surface area of 400 cm² installed in the interior wall. The experiment was performed under constant current density and flow rate, i.e., 50 mA cm⁻² and 5.5 L/min.

### Example 11

The peroxydisulphate and metal concentration, oxidation strength and pH values obtained during metal recovery from e-waste was measured and is described in the following paragraphs. Peroxydisulphate concentration was measured using a ThermoFisher ion chromatograph. Dissolved metals were measured using inductively coupled plasma (ICP). Oxidation strength and pH were measured using a Mettler Toledo multiparameter sensor probe.

### Approach 1: Electro-Oxidation in an Undivided Cell for In-Situ Leaching of Metals

In the first approach, an electro-oxidation step was performed in the lab-scale electrolyser with undivided configuration. In-situ leaching is defined as the production of peroxydisulphate oxidiser from sulfate oxidation and its immediate consumption to oxidise Fe²⁺ and the pre-loaded solid metal sample (e.g., e-waste) in the anolyte reservoir. The main reactions that potentially occur in the electrolytic cell using this approach are shown in FIG. 15.

Approach 1 was tested in the absence of solid metal samples to observe the production rate of peroxydisulphate from sulphate oxidation in the BDD anode. After 2 h of operation, only a low amount of peroxydisulphate concentration (~7% yield) was measured in the solution. Without wishing to be bound by theory, the low production of peroxydisulphate in this configuration suggests that there is a competitive reaction preventing peroxydisulphate accumulation in solution. In the undivided electrolyser configuration, peroxydisulphate ion migrated to the cathode and reduced back to sulphate ion.

Copper wire (representing e-waste sample) was then introduced into the system to observe the leaching rate of copper in undivided cell configuration. ~30% of copper leaching was achieved after 3 h of operation time. Most of the leached copper was deposited at the cathode side suggesting that the dissolved copper was electrodeposited at the cathode.

### Approach 2: Electro-Oxidation in a Divided Cell for In-Situ Leaching of Metals

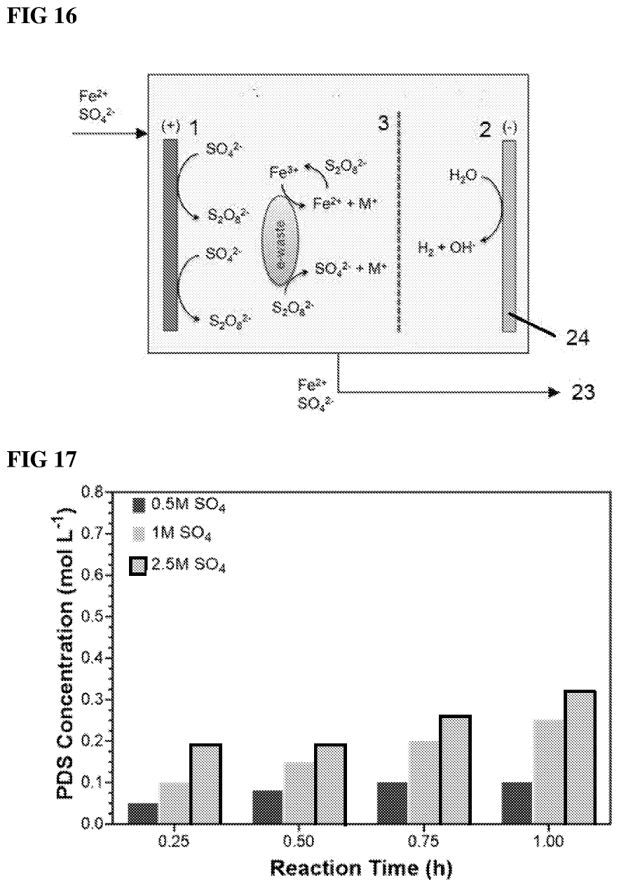

In the second approach, the electro-oxidation step was performed in the electrolyser with the anode and cathode compartment separated by a monovalent-selective anion exchange membrane. The membrane allowed only monovalent ions such as Cl⁻ and Br⁻ to pass through the membrane. The oxidisers generated (i.e., peroxydisulphate and Fe³⁺) were then isolated in the anolyte compartment and were therefore not reduced. At the end of the process, the anolyte solution contained dissolved metals which can be further recovered in a separate unit of operation. The main reactions that could occur in the electrolytic cell using this approach are shown in FIG. 16.

The use of the membrane provided a significant difference in the production of peroxydisulphate. In the absence of solid metal sample, a considerable amount of peroxydisulphate (~48% yield) was measured in the anolyte solution; suggesting that the membrane eliminated any competitive reaction that may oppose the peroxydisulphate evolution. The membrane potentially prevents the reduction of peroxydisulphate on the cathode side. When copper wire was introduced into the system, ~50% of copper extraction was achieved after 3 h of operation time. Transparent blue anolyte and colourless catholyte solutions were visually observed at the end of the process, suggesting that the dissolved copper was isolated in the anolyte solution.

Based on these two approaches, divided cell configuration shows a better performance in oxidiser production and copper leaching. The following results were collected from experiments in divided cell configuration.

### Results

FIG. 17 shows a profile of peroxydisulphate concentrations and yields as a function reaction time. Production of peroxydisulphate was conducted in a microflow electrolytic cell at varying initial sulphate concentrations (i.e., 0.5, 1, and 2.5 M) with current density and flow rate of 150 mA cm⁻² and 50 mL min⁻¹, respectively. As can be seen in FIG. 17, peroxydisulphate concentration shows an increasing trend as the reaction time increases from 0.25 to 1 h in all investigated initial sulphate. The same trend can be observed at varying initial sulphate concentrations in each reaction time; where a higher concentration of initial sulphate produces a higher amount of peroxydisulphate. This trend highlights the importance of the initial sulphate concentration in influencing peroxydisulphate production and can have significant implications for optimising the electrochemical process for metal extraction.

Production of peroxydisulphate was also tested using anion and cation exchange membrane. There is no significant difference in peroxydisulphate production, suggesting that both membranes can prevent migration of peroxydisulphate to the cathode side.

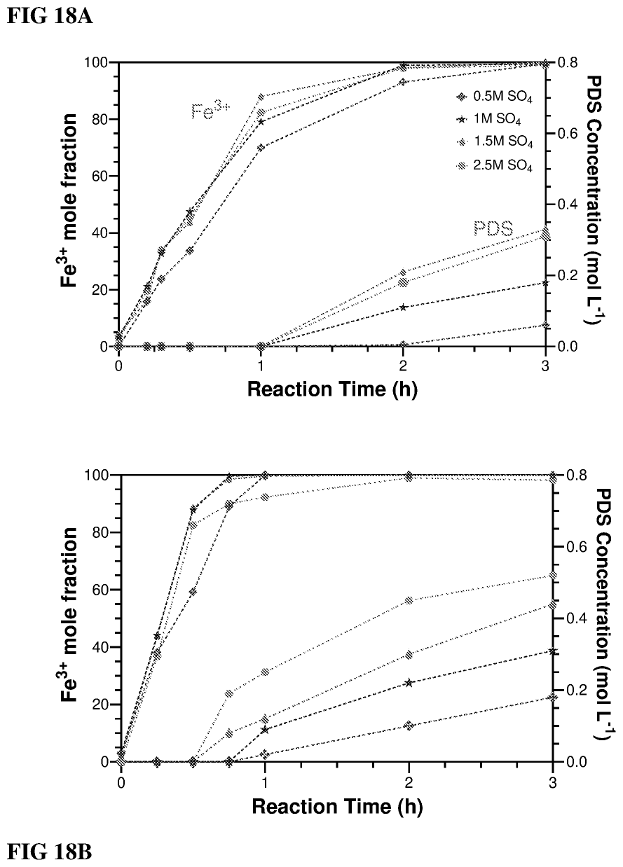

FIG. 18 shows the profile of ferric and peroxydisulphate concentrations as a function of reaction time at varying initial sulphate and ferrous concentrations. As shown in FIG. 18, at a constant initial ferrous concentration of 0.5 M, the production rate of ferric ions is independent of the initial sulphate concentrations, i.e., complete conversion of ferrous to ferric ion was achieved within 2 h. Evolution of peroxydisulphate was observed after 1 h reaction time—gradually increasing to 0.05-0.35M at 3 h reaction time.

Without wishing to be bound by theory, the mechanism of peroxydisulphate production was presumably initiated by the electro-oxidation of sulphate ion to produce peroxydisulphate (shown in equation (3)).

$$2 {SO}_{4}^{2 -} \to {{S}_{2} O}_{8}^{2 -} + 2 {e}^{-} \qquad equation ( 3 )$$

Peroxydisulphate is a stable oxidising agent which will subsequently oxidise ferrous to ferric ion. The reaction of peroxydisulphate with ferrous ion proceeds with the stoichiometric ratio of 1, i.e., 1 mole of peroxydisulphate reacts with 1 mole of ferrous, to produce 1 mole of ferric ion—as shown in equation (4).

$${Fe}^{2 +} + {S}_{2} {O}_{8}^{2 -} \to {{Fe}^{3 +} + 2 SO}_{4}^{2 -} \qquad equation ( 4 )$$

Based on FIG. 18, complete conversion of ferrous ions to ferric ions with initial ferrous concentrations of 0.25 M and 0.5 M was achieved after 0.5 h and 1 h of reaction time, respectively. This result is aligned with the observations made with respect to FIG. 13, where ~0.3 M and ~0.6 M of peroxydisulphate were produced after 0.5 h and 1 h of reaction time. Peroxydisulphate was consumed to facilitate the oxidation of ferrous to ferric ions. Consequently, the evolution of peroxydisulphate in the solution will only proceed when a complete conversion of ferrous to ferric ion has been achieved-which occurred after 1 h reaction time.

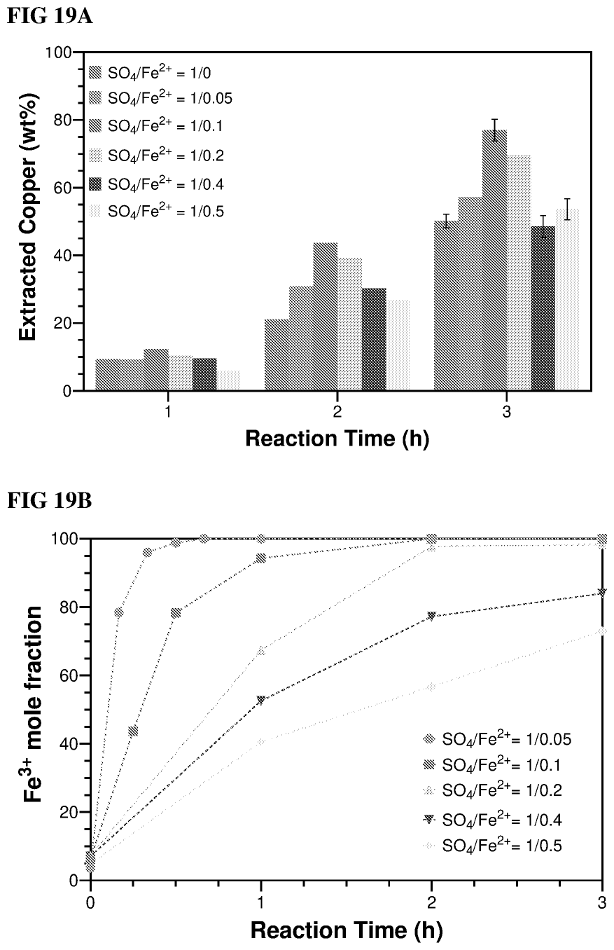

The ferric ion production rate is considerably faster at a lower initial ferrous concentration (e.g., 0.25 M), where a complete conversion of ferrous ions to ferric ions was achieved after 45 min reaction time (as shown in FIG. 19B). The initial sulphate concentrations did not impact the ferric ion production rate, consistent with those observed in an initial ferrous concentration of 0.5 M.

FIG. 19 illustrates the profile of copper extraction and ferrous ion concentration as a function of reaction time at varying SO₄²⁻/Fe²⁺ ratios. As shown in FIG. 19A, the amount of extracted copper showed a steady increase as a function of reaction time in respect of all SO₄²⁻/Fe²⁺ ratios. The SO₄²⁻/Fe²⁺ ratio had no apparent effect on copper extraction over 1 h of reaction time as only a relatively low amount of copper (~15%) was extracted. In the absence of ferrous ions, ~50% of copper was extracted after 3 h of reaction time. The addition of ferrous ions to the leaching process, i.e., SO₄²⁻/Fe²⁺ ratio of 1/0.1, enhanced the copper extraction rate to ~75%, whilst further increasing the SO₄²⁻/Fe²⁺ ratio to 1/0.5 resulted in ~57% extraction of copper.

The profile of ferric ion production as a function of reaction time at varying SO₄²⁻/Fe²⁺ ratio is shown in FIG. 19B. It is clear that the initial concentration of ferrous ions affects the ferric ion production rate. At low concentrations of ferrous ions (e.g., SO₄²⁻/Fe²⁺=1/0.05 and 1/0.1), a complete conversion of ferrous ions to ferric ions occurred within 1 h. Further increase of the SO₄²⁻/Fe²⁺ ratio to 1/0.5 resulted in slower conversion of the ferrous ions to ferric ions, i.e., ~70-80% conversion of the ferrous ions was achieved after 3 h.

At a low ferrous concentration (SO₄²⁻/Fe²⁺ ratio=1/0.05 and 1/0.1), peroxydisulphate was consumed to oxidise ferrous and leach copper wire over 1 h and resulted in a low amount of extracted copper (~15%). Once a complete conversion of ferrous has been achieved (after 1 h), the copper leaching was then assisted by ferric ions and peroxydisulphate
resulting in significant increases in the copper leaching rate, i.e., from ~10% to 75% as the reaction time increased from 1 h to 3 h. When a higher concentration of ferrous ions was introduced (e.g., SO₄²⁻/Fe²⁺=1/0.4 and 1/0.5), peroxydisulphate was exhausted in oxidising ferrous to ferric. At this condition, the copper leaching was presumably assisted only by ferric ions. The amount of copper extracted at SO₄²⁻/Fe²⁺=1/0.5 compares relatively well with the amount extracted in the absence of ferrous ion (SO₄²⁻/Fe²⁺=1/0), i.e., 50% extraction of copper by a single oxidiser was achieved after 3 h reaction time. The trend shown in FIG. 19 suggests that a ratio of SO₄²⁻/Fe²⁺=1/0.1 is the optimum oxidiser ratio at which copper extraction can be maximised. This corroborates the results presented in FIG. 13 and FIG. 14; where the evolution of oxidisers was initiated by the production of peroxydisulphate and could subsequently oxidise any species in the solution.
   Metal Extraction from Electronic Waste at Lab-Scale

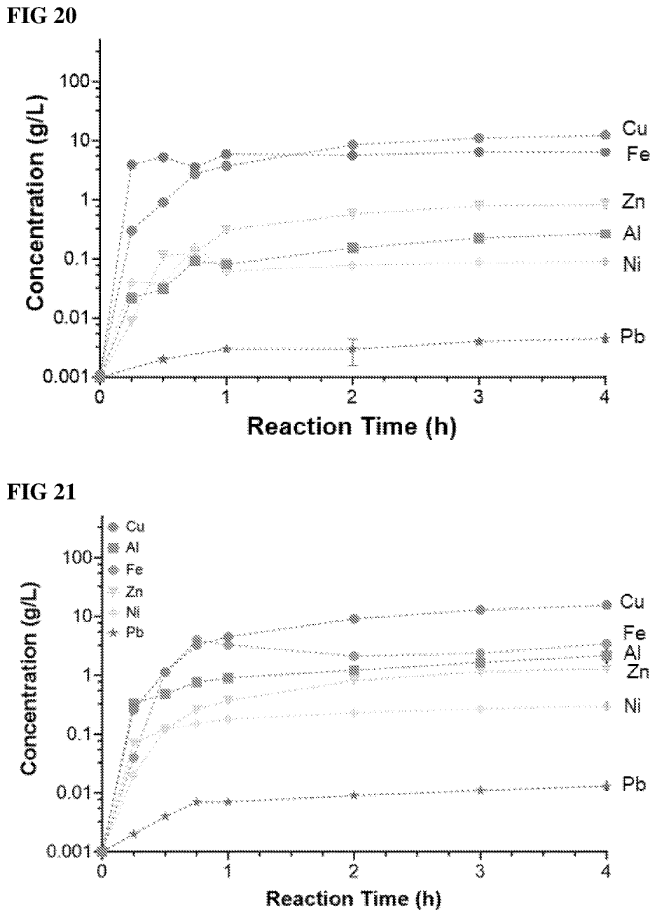

FIG. 20 shows the profile of metal concentration in the post-leaching solution as a function of reaction time. The leaching was performed in a lab-scale electrolyser at current density of 150 mA cm⁻², SO₄²⁻/Fe²⁺=1/0.1, and flow rate=50 mL min⁻¹. Elements measured in the solution included Cu, Al, Fe, Zn, Ni and Pb.

As can be seen in FIG. 20, all metal concentrations rose in the first 1 h of the reaction, tapered off after 2 h and then remained steady until 4 h of reaction time. Cu and Fe were the most abundant elements measured in the post-leaching solution (reaching ~10 g/L and ~7 g/L, respectively, after 4 h leaching). Concentration of other elements including Zn, Ni, Al and Ni were in the range of 0.1-0.5 g/L, whilst concentration of Pb in the solution was <0.005 g/L.

Considering Cu and Fe are the most abundant elements in e-waste, it is understandable that Cu and Fe concentrations in the post-leaching solution is relatively higher than other elements. In a comparison of Zn vs Al extraction however, Zn concentration was higher than Al (0.8 vs 0.2 g/L), whilst Zn content in the e-waste was lower than Al (1.7% vs 5.7%). This trend may suggest that leaching rate of metals in e-waste is not uniform, i.e., Zn show higher leaching rates than Al.

Metal Extraction from Electronic Waste at Pilot-Scale

The concentration of metal in the anolyte solution collected from pilot-scale electrolyser is shown in FIG. 21. As illustrated, all metal concentrations rose in the first 1 h of reaction time, tapered off after 2 h and then remained steady until 4 h of reaction time. Cu and Fe were the most abundant elements measured in the post-leaching solution (reaching ~15 g/L and ~3 g/L, respectively, after 4 h leaching). The concentration of other elements including Zn, Al and Ni were in the range of 0.3-2.2 g/L, whilst Pb concentration was <0.01 g/L. Overall, the elements measured in the post-leaching solution from the pilot-scale electrolyser followed the same distribution that was observed in the corresponding lab-scale electrolyser.

ORP is a critical parameter in the leaching process as it indicates whether the solution is oxidative or reductive. A positive ORP value suggests that a solution is oxidative, while a negative value suggests a reducing solution. FIG. 25 shows ORP as a function of reaction time for leaching processes undertaken in the lab-scale and pilot-scale electrolyser. The ORP showed an increase from ~400 to 1000 mV during 4 h of reaction time in both cases, suggesting that the electrolysers produced oxidative solutions for metals leaching.

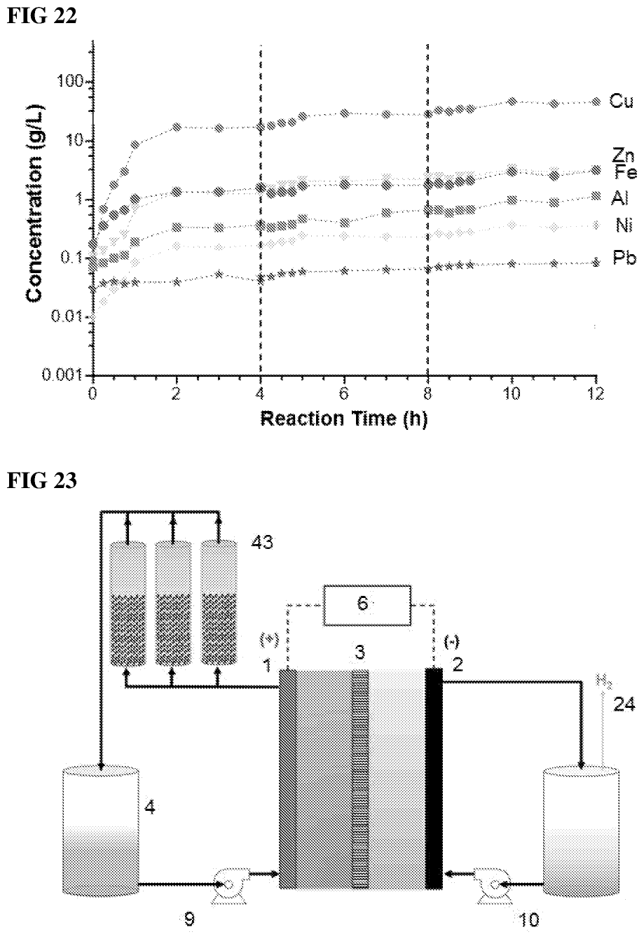

FIG. 22 shows the profile of metal concentrations in post-leaching solutions for 3 batches of e-waste. The operating time and e-waste loading for each batch was 4 h and 50 g, respectively, and 2.5 M of sulfuric acid was used as the oxidiser precursor for batch 1. At the end of each batch processing, the remaining solid was collected and the solution was reused for metal extraction of batch 2 and 3.

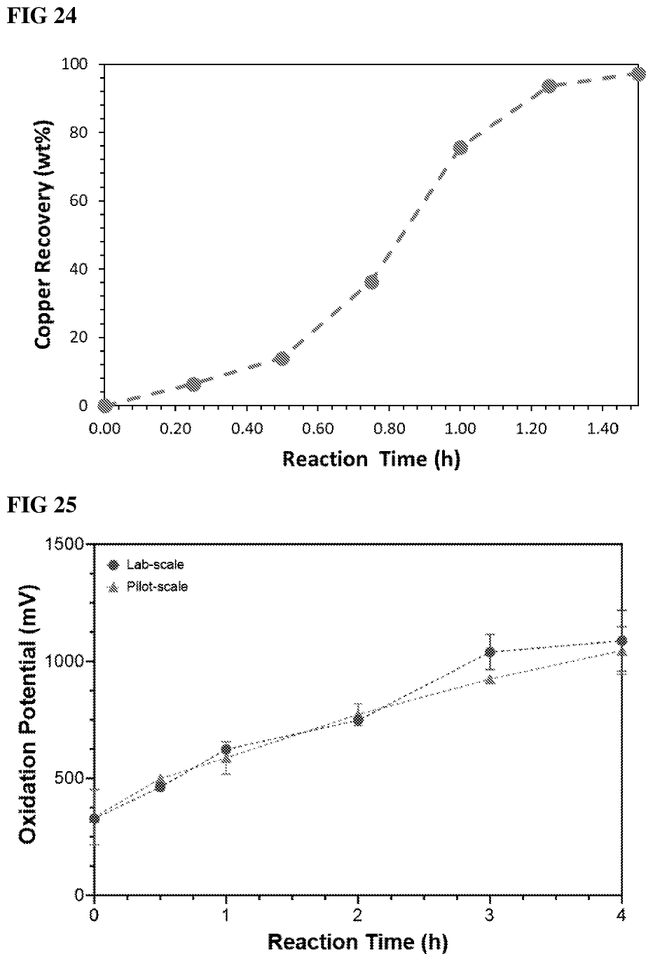

FIG. 24 shows the profile of copper recovery as a function of reaction time. Complete copper recovery (~99%) was achieved in approximately 90 min of operation time.

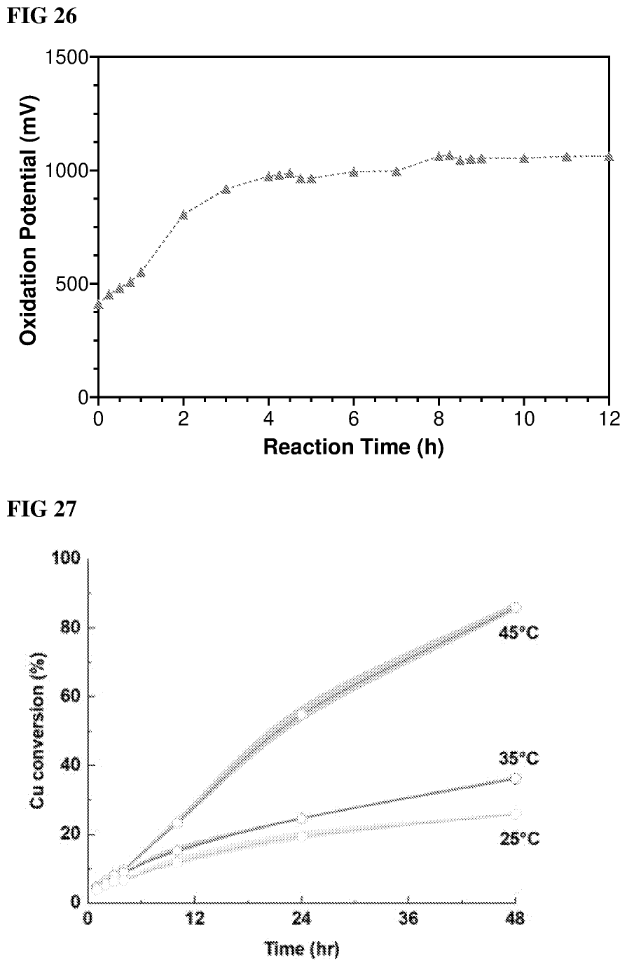

Cu was the most abundant element extracted in all batches and approximately ~15 g/L of copper was extracted each batch. Other metals that were extracted, including Fe, Al, Fe, Zn, Ni and Pb, all followed the same trend, as Cu. Approximately 1.3 g/L of Fe and Zn, ~0.35 g/L of Al and ~0.16 g/L of Ni were leached in each batch. The concentration profile of metals presented in FIG. 22 demonstrates that an electrolyser according to the present invention maintains the same performance in extracting metals for multiple loads of e-waste. It further demonstrates that the leaching solution can be recycled multiple times with the same oxidation strength. FIG. 26 shows the profile of ORP for the leaching process at the condition presented in FIG. 19. The ORP shows an increase from ~400 to 1000 mV after 4 h of reaction time in batch 1 and this value remained steady at around ~1000 mV when the solution was used to leach metals from two subsequent loads of e-waste. The ORP profile shown in FIG. 26 clearly demonstrates the capability of an electrolyser according to the present invention to regenerate the oxidiser for metal leaching, thus offering a promising green process for metals extraction from e-waste.

FIG. 23 shows a design for a commercial electrolyser for use with the method of the present invention. Multiple e-waste beds (43) can be installed in parallel at the outlet stream of anolyte (4). Extraction of e-waste can proceed by passing the anolyte stream into one e-waste bed at a time until most metals have been extracted. Once this has been achieved, the anolyte outlet stream can then be switched into the second e-waste bed for further metal extraction. While the electrolyser extracts metals from the second e-waste bed, retentate from e-waste beds can be collected for further treatment. This step can be repeated for metals extraction from e-waste beds. Following this approach, the electrolyser can be used for continuous metal extraction using the same oxidiser solution.

### Leaching of Ores

### Example 12

In this example, chalcopyrite was obtained and ground to D90 45 μm. Ore phases of chalcopyrite were measured by X-ray diffractometer (XRD) produced from Rigaku Smartlab. The target was CuKα, and tube current was 40 mA. The tube voltage was 40 kV, and scan range 2θ was 15-80°. The sample compositions were characterised by using X-ray fluorescence (XRF) produced from Rigaku Supermini200™.

Analysis was conducted to understand the effect of copper recovery from chalcopyrite with varying temperature. A range of temperatures were investigated; 25 °C, 35 °C and 45 °C. The effect of ultrasound and stirring speed on rate of recovery of copper was also conducted.

Electrolyser Apparatus for Metal Leaching from Chalcopyrite

The electrolyser for metal leaching from ores was built at a lab scale. The electrolyser consisted of a working electrode (anode) and counter electrode (cathode) with an anion exchange membrane separating the electrode compartments. The anode was made of BDD material, whilst a platinum plate was used as a cathode. Experimental metal leaching from chalcopyrite ore was performed under a current density of 25-100 mA cm⁻² from a DC power supply.

Two reservoirs (pre-loaded with 100 mL of solution) were used to separately recirculate the solution through anode and cathode compartments. Both reservoirs were loaded by oxidiser precursor solution with 2.5 M of initial sulphate concentration, SO₄²⁻/Fe²⁺=1/0.1 and in a typical run, 2 g of chalcopyrite ore samples were loaded into the anolyte reservoir. A mechanical stirrer was utilised to increase mass transfer at a stirring speed of 400-1000 r/min. The BDD anode was sized at 2.25 cm² and the platinum cathode was at 1.5 cm².

The metal concentrations in the leach digestion solutions were determined using an Aquaculture Photometer. A 3M KCl electrode was used as a reference electrode. The electrolytic cell was placed in an ultrasound water bath (Unisonics—FXP10™) with power of 500 W and frequency of 40 KHz.

### Approach 1: Temperature Effect on Electro-Oxidation in a Divided Cell for In-Situ Leaching of Metals

In the first approach, an electro-oxidation step combining varying temperatures was performed in the lab-scale electrolyser with divided configuration to investigate the effect of temperature on copper conversion rate. In-situ leaching is defined as the production of peroxydisulphate oxidiser from sulphate oxidation and its immediate consumption to oxidise Fe²⁺ and the pre-loaded solid metal sample (e.g., chalcopyrite ore) in the anolyte reservoir.

Approach 1 was tested at a range of temperatures (25 °C, 35 °C and 45 °C) to observe the efficiency of the copper conversion rate as a result of temperature. After 48 hours of operation, efficiency of copper conversion during the electrolysis process is notably affected by temperature. FIG. 27 shows that as time progresses, an increase in temperature significantly enhances the conversion efficiency of copper. At 45 °C, the conversion efficiency of copper reaches approximately 84.75% after 48 hours, whereas at 25 °C and 35 °C, the conversion efficiencies are 25.79% and 35.69%, respectively.

From the perspective of surface reaction rate, higher temperatures aid in accelerating the reaction rates of reactive oxygen species (ROS) and peroxydisulfate (PDS) with chalcopyrite.

In terms of the production of oxidants, higher temperature conditions favour the generation of oxidants like hydroxyl radicals (·OH) and sulphate radicals (SO_{\dot{4}}⁻). Involving more radical oxidants is crucial for accelerating the leaching process.

### Approach 2: Mixing Effect on Electro-Oxidation in a Divided Cell for In-Situ Leaching of Metals

In the second approach, an electro-oxidation step combining varying stirring speeds was performed in the lab-scale electrolyser with divided configuration to investigate the effect of stirring speed on copper conversion rate.

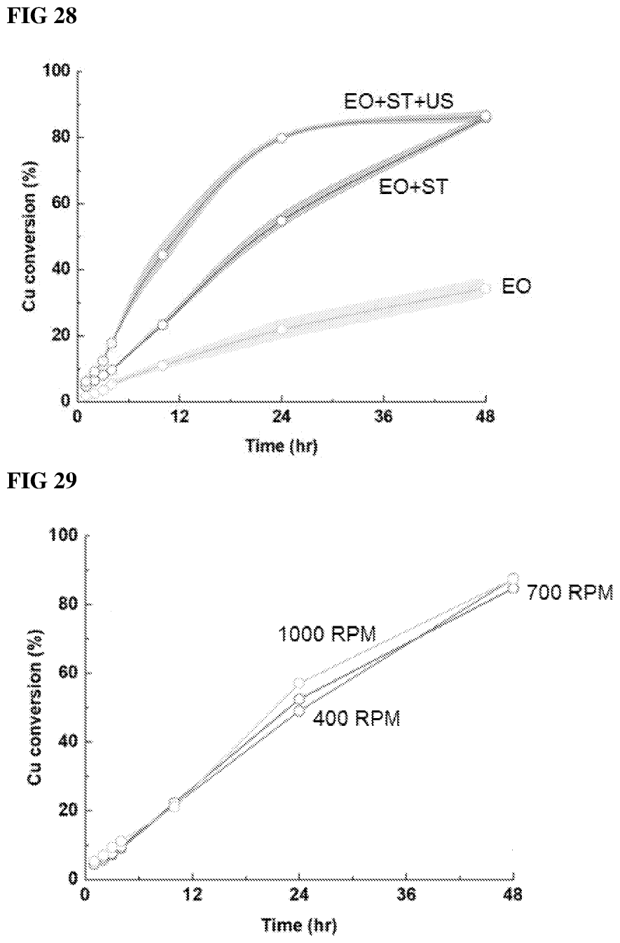

Approach 2 was tested at a range of stirring speeds (400-1000 r/min) to observe the efficiency of the copper conversation rate as a result of stirring speed. After 48 hours of operation, efficiency of copper conversion during the electrolysis process is notably affected by stirring speed. FIG. 28 shows that as time progresses, an increase in stirring speed significantly enhances the conversion efficiency of copper. At 700 r/min, the conversion rate elevates to 52.50% after 48 hours, compared to 24.90% with no stirring at all.

Upon the integration of stirring into the reaction system, the mass transfer of ore is significantly enhanced, allowing the ore to reach the ROS reaction zone on BDD. This facilitates the engagement of ROS in the leaching process. The significant uptick in the leaching rate is attributed to the ROS involvement, as mirrored in the data.

Moreover, FIG. 29 corroborates that the stirring rate variance between 400-1000 RPM doesn't significantly impact the leaching conversion, hinting that a stirring rate exceeding 400 RPM suffices to obliterate the mass transfer limitation between ore particles and oxidant for radical oxidants. This indicates a pivotal shift in the limitation step from mass transfer to the production of ROS, once a certain stirring rate is integrated into the system.

### Approach 3: UV Effect on Electro-Oxidation in a Divided Cell for In-Situ Leaching of Metals

In the third approach, an electro-oxidation step combining the use of UV was performed in the lab-scale electrolyser with divided configuration to investigate the effect of UV on copper conversion rate.

Approach 3 was tested using UV to observe the efficiency of the copper conversation rate as a result of placing the electrolytic cell in an ultrasound water bath with power of 500 W and frequency of 40 KHz. After 48 hours of operation, efficiency of copper conversion during the electrolysis process is significantly affected.

The efficacy of copper conversion from chalcopyrite in the electro-leaching system is notably augmented through ultrasound, which predominantly focuses on enhancing mass transfer within the system. FIG. 28 outlines a stark enhancement in conversion rates when this mechanism is employed. At 24 hours, the conversion rate elevates to 80.73% compared to 24.90% with electro-oxidation alone.

### Example 13

Analysis was conducted to understand the recovery of metals leached from two high grade nickel ores, Nickel Ore 1 and 2, which both had a particle size of <3.35 mm. Leached metals including nickel, iron, copper, cobalt, manganese and chromium were investigated.

Electrolyser Apparatus for Metal Leaching from Nickel Ores

The electrolyser for metal leaching from ores was built at a lab scale. The electrolyser consisted of a working electrode (anode) and counter electrode (cathode) with an anion exchange membrane separating the electrode compartments. The anode was made of BDD material, whilst a stainless steel plate was used as a cathode. Experimental metal leaching from nickel ores was performed under a current density of 150 mA cm⁻² from a DC power supply.

Two reservoirs (pre-loaded with 120 mL of solution) were used to separately recirculate the solution through anode and cathode compartments. Both reservoirs were loaded by oxidiser precursor solution with 2.5 M of initial sulphate concentration, SO₄²⁻/Fe²⁺=1/0.1. In a typical run, 5 g of nickel ore sample was loaded into the anolyte reservoir.

Metal Extraction from Nickel Ores at Lab-Scale

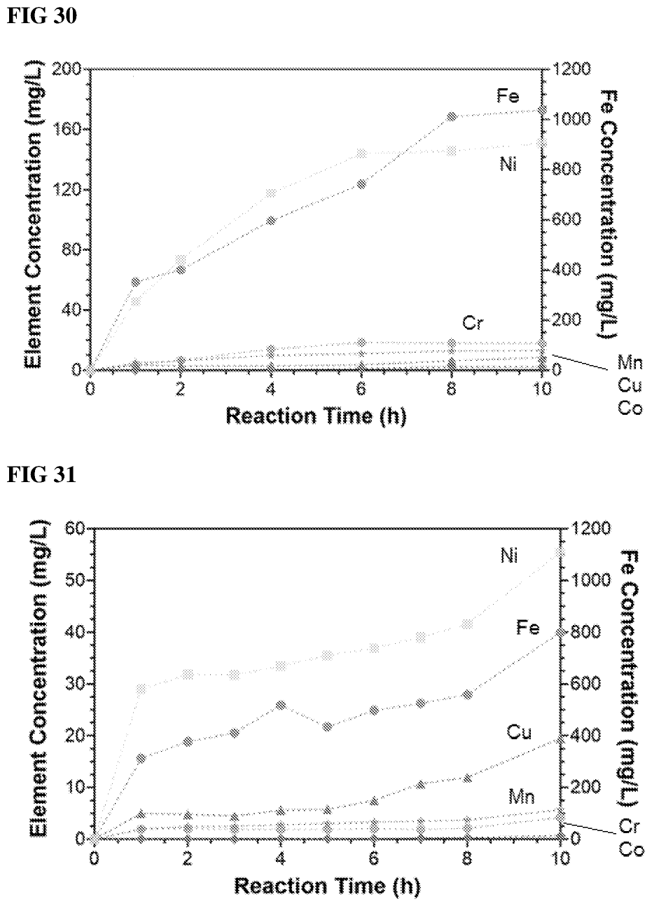

FIG. 30 and FIG. 31 show the profile of metal concentration in the post-leaching solution as a function of reaction time for both Nickel Ore 1 and 2 respectively. The leaching was performed in a lab-scale electrolyser at current density of 150 mA cm⁻², SO₄²⁻/Fe²⁺=1/0.1, and flow rate=50 mL min⁻¹. Elements measured in the solution included Ni, Cu, Co, Fe, Mn and Cr.

As can be seen in FIG. 30, all metal concentrations from Nickel Ore 1 rose in the 10 hours of the reaction. Ni and Fe were the most abundant elements measured in the post-leaching solution (reaching ~140 mg/L and ~1050 mg/L, respectively, after 4 h leaching). Concentration of other elements including Co, Co, Mn and Cr, were in the range of 2-20 mg/L.

FIG. 31 shows that all metal concentrations from Nickel Ore 2 increased over the 10 hours of the reaction, however, again, Ni and Fe were the most abundant elements in post-leaching solution. In both cases, this can be expected as Ni and Fe are the most abundant of the elements in the original ore.

### Example 14

Analysis was conducted to understand the recovery of metals leached from ores containing vanadium. Leached metals including vanadium, iron, chromium, nickel, cobalt and manganese were investigated. Characterisation of the ore was conducted via aqua regia microwave digestion at 180 °C, 3 bar for 30 min.

Electrolyser Apparatus for Metal Leaching from Vanadium Ores

The electrolyser for metal leaching from ores was built at a lab scale. The electrolyser consisted of a working electrode (anode) and counter electrode (cathode) with an anion exchange membrane separating the electrode compartments. The anode was made of BDD material, whilst a stainless steel plate was used as a cathode. Experimental metal leaching from vanadium ores was performed under a current density of 150 mA cm⁻² from a DC power supply.

Two reservoirs (pre-loaded with 120 mL of solution) were used to separately recirculate the solution through anode and cathode compartments. Both reservoirs were loaded by oxidiser precursor solution with 2.5 M of initial sulphate concentration, SO₄²⁻/Fe²⁺=1/0.1. A solid concentration of 10% was used. Elements measured in the leached solution included V, Fe, Cr, Co, Mn, Ni.

Metal Extraction from Vanadium Ores at Lab-Scale

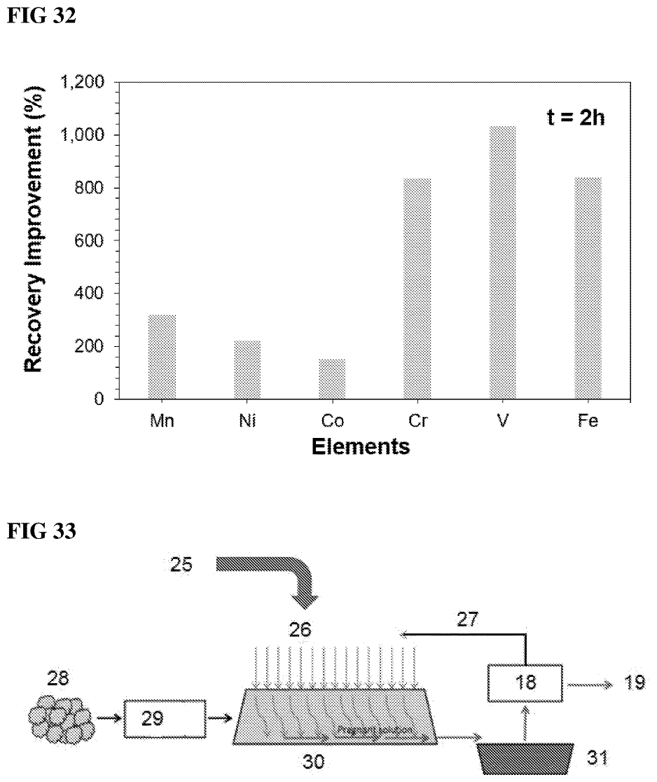

FIG. 32 shows the metal recovery improvement after 2 hours of treatment in the electrolyser using the anolyte solution with respect to standard acid leaching with 2.5M H₂SO₄ alone. It is evident that there is a significant improvement in metal recovery, primarily apparent with V, Fe and Cr (1000% recovery improvement for V and 820% for each of Fe and Cr).

### Example 15

The above findings can be extended to achieve improved recovery of metals in industrial scale recovery of metals from ores, landfill residues, sludges, tailings, slags, ashes, filter dust from incinerators, blanks, e-waste or other waste containing metals. A specific example is for recovery of metals from low grade ores or tailings in the mining sector. These hydrometallurgical processes mainly include heap leaching, in-situ leaching and tank leaching.

### Approach 1: Use of Analyte Solution for Accelerated Recovery of Metals in Heap Leaching

In this example, the anolyte solution may be generated and supplied on-site to replace reagents such as acid sulphate or alkaline carbonate in heap leaching of ores and tailings at a mine site. In heap leaching, mined ore, such as precious metals, copper, nickel and uranium, is crushed and placed on an impermeable plastic or clay lined leach pad. The heap is irrigated with a leach solution to dissolve metals within the ore, which are then recovered. The anolyte solution can be used as a leaching solution in place of standard acid or alkaline reagents for irrigation of a heap of tailings or low grade ores, thus leaching metal into the pregnant solution. The pregnant solution containing the dissolved metals is subsequently processed for metal recovery by standard methods. FIG. 33 illustrates the standard process for heap leaching of copper from low grade ores. The improvement with respect to the standard process is increased efficiency of metal recovery through use of the anolyte solution in place of, for example, acid sulphate, as depicted in the case of copper in FIG. 28 and in the case of V, Fe, Cr, Co Mn, Ni in FIG. 32.

### Approach 2: Use of Analyte Solution for Accelerated Recovery of Metals in Tank or Vat Leaching

In this example, the anolyte solution may replace standard leaching reagents (e.g. sulphuric acid) in the tank or vat leaching process. Tank and vat leaching involves placing ore, or other solids containing metals, usually after size reduction and classification, into large tanks that are then flooded with leaching solution (in the case of vat leaching), or ground and mixed with water to form a slurry before leaching reagents are added (in the case of tank leaching).

In some cases, tanks are equipped with agitators and baffles to maintain solids in suspension and hence increase efficiency of metal extraction. Agitated vessels are either vertical or horizontal closed cylindrical vessels with power-driven paddles or stirrers on vertical or horizontal shafts. They have a provision at the bottom for the withdrawal of leach solution at the end of the operation. In some of the designs, the horizontal drum is the extraction vessel, and the solid and liquid are tumbled about inside by rotation of the drum on rollers. They are operated on batch basis and each one is a single leaching stage. They can also be used in series for a multistage operation.

For the leaching of finely divided solids, a pachuca tank is used. This finds extensive use in metallurgical industries. These tanks are constructed with wood, metal or concrete and lined with suitable material depending on the nature of leaching liquid. Agitation is accomplished by air lift. The bubbles rising through the central tube cause the upward flow of liquid and suspended solid in the tube and hence circulation of the mixture. Conventional mechanical agitators are also used for this purpose.

Once the desired leaching is achieved, the agitation is stopped, the solids are allowed to settle and the clear supernatant liquid is decanted by siphoning over the top of the tank, or by withdrawal through discharge pipes placed at appropriate levels in the side of the tank. The solids settle to form a compressible sludge, the solution retained will be more and generally the last traces of solute in such cases are recovered in counter-current manner. In the new embodiment, the anolyte solution would act as the electrolyte, increasing efficiency of metal recovery versus use of, for example, acid sulphate, as depicted in the case of copper in FIG. 28 and in the case of V, Fe, Cr, Co Mn, Ni in FIG. 32. Further enhancements are achieved via optimisations including temperature, stirring speed and use of UV, as shown in FIGS. 27 and 28.

### Approach 3: Use of Analyte Solution for Accelerated Recovery of Metals in Counter Current Separation

In a continuous variation of the tank and vat processes, counter current leaching is used to more efficiently extract metals from materials such as ore, concentrate, slag, slime, chips and metals waste (and other terms used by industry to explain waste that contains metals). There are many variables with this approach, though the principles of solvent strength, contact time, surface area, temperature and flow rate will all remain key components of the process.

Important factors in CCE extraction include what the target metal for extraction is and what material it is contained within. In addition, how the target is prepared will also be a factor in the successful operation of the many CCE processes. For example, lithium will need to be baked and crushed prior to beginning the leaching process, while ores like copper and nickel will require crushing to a uniform size for extraction.

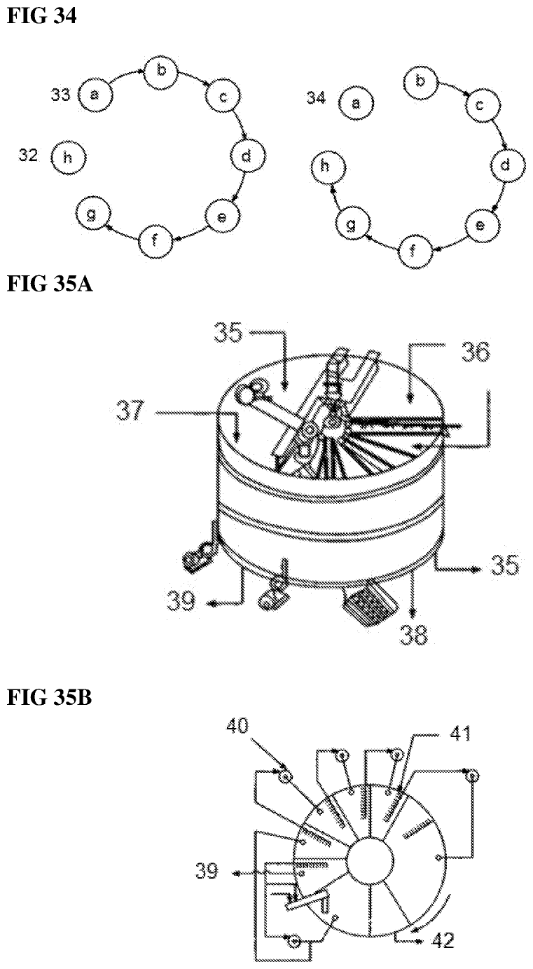

While there are many forms of CCE, from very simple pump over processes in a tank containing ore, through to very sophisticated agitation systems and tank arrangements, commonly known as the shanks system (FIG. 34), the concept of CCE remains the same. As illustrated in FIG. 34, solids or slurries move counter currently to the liquid flow (separately, in the direction of the arrow from (a) to (h)), with importance placed on selection of an effective solvent.

At times the pressure drop for flow of liquids by gravity is high or the solvent is highly volatile. Under such circumstances the liquid is pumped through the bed of solids in vessels called diffusers. The main advantage of these units is the prevention of evaporation losses of solvent, when they are operated above the boiling point of the solvent. The use of percolation tanks fit this operation, though they are not suitable if the ore or target is in a very fine form. Under such circumstances, solids can be filtered and leached in the filter press by pumping the solvent through the press cake.

The Rotocel extractor, depicted in FIG. 33, is a modification of shanks system wherein the leaching tanks are continuously moved, permitting a continuous introduction and discharge of solids. It consists of a circular shell partitioned into several cells each fitted with a hinged screen bottom for supporting the solids. This shell slowly revolves above a stationary compartmented tank. As the rotor revolves, each cell passes in turn under the prepared solids feeder and then under a series of sprays by which the contents in each cell is periodically drenched with solvent for leaching. By the time one rotation is completed, when the leaching is expected to be completed, the leached solids of each cell are automatically dumped into one of the lower stationary compartments, from which they are continuously conveyed away. The solvent sprayed over each cell filled with solids, percolates downward through the solid and supporting screen into the appropriate compartment of the lower tank from which it is pumped to the next spray. The leaching is counter-current, and the strongest solution comes from the cell which is filled with fresh solid. The improvement with respect to the standard process is increased efficiency of metal recovery through use of the anolyte solution. The improvement with regard to sulphuric acid is depicted in the case of copper in FIG. 30.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

When a Markush group or other grouping is used herein, all individual members of the group and all combinations and sub-combinations possible of the group members are intended to be individually included in the disclosure. Every combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

One of ordinary skill in the art will appreciate that materials and methods, other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by examples, preferred embodiments and optional features, modification and variation of the concepts herein disclosed may be resorted to by those skilled in the art, and that such modifications and variations are considered to be within the scope of this invention as defined by the appended claims.

### LIST OF PARTS

The figures and the description herein should be read with reference to the following item numbers that appear in the drawings and text:

| | |
|---|---|
| 1. Anode | 2. Cathode |
| 3. Membrane | 4. Anolyte |
| 5. Catholyte | 6. DC Power Supply |
| 7. Electrolyser | 8. Peristaltic Pump |
| 9. Electro-Oxidation Anode Cell | 10. Electro-Reduction Cathode Cell |
| 11. Annular Cell | 12. Cell Discharge |
| 13. Cell Feed | 14. Electrolyte Pump |
| 15. Circulation Tank | 16. Electro-oxidation |
| 17. Metal Leaching | 18. Metal Recovery |
| 19. Recovered Metals | 20. Spent Solution |
| 21. Particulate e-Waste | 22. Metal deposit |
| 23. Metal-rich Solution | 24. Hydrogen Generation |
| 25. Oxidant | 26. Solution Application |
| 27. Lixivant Solution | 28. Ore |
| 29. Crushing and agglomeration | 30. Heap |
| 31. Pregnant solution pond | 32. Fresh solid |
| 33. Concentrated Extract | 34. Spent solid |
| 35. Interstage Solution | 36. Fresh Solvent Spray |
| 37. Solids Feed | 38. Solids Discharge |
| 39. Extract | 40. Pumps for Solvent/Solution Spray |
| 41. Solvent/Solution in Spray | 42. Solids |
| 23. E-Waste Beds | |

1. A method for generation of an oxidant solution using an electrochemical cell having an anode and a cathode, the method comprising the steps of:
(i) supplying a feedstock electrolyte to a reaction area between the anode and cathode, the feedstock electrolyte consisting of sulphate ions (SO₄²⁻) and ferrous ions (Fe²⁺);
(ii) in an operational cycle, electrolysing the feedstock electrolyte to produce an oxidised acid solution comprising peroxydisulphate (S₂O₈²⁻) and ferric ions (Fe³⁺); and
(iii) supplying said oxidised acid solution.

2. The method according to claim 1 wherein the concentration of sulphate ions (SO₄²⁻) in the feedstock electrolyte is between 0.1 molar and 5 molar.

3. The method according to claim 1 wherein the concentration of ferrous ions (Fe²⁺) in the feedstock electrolyte (Fe²⁺) is between 0.1 and 0.5 molar.

4. The method according to claim 1 wherein the ratio of SO₄²⁻:Fe²⁺ is between 1:0.05 and 1:0.5.

5. The method according to claim 1 wherein the anode comprises boron doped diamond.

6. The method for generation of an oxidant solution using an electrochemical cell according to claim 1 having an anodic half-cell comprising the anode and a cathodic half-cell comprising the cathode, the method comprising the steps of:
(i) supplying to the anodic half-cell, the feedstock electrolyte which enters and exits a fluid path formed between the anode and cathode, the feedstock electrolyte consisting of sulphate ions (SO₄²⁻) and ferrous ions (Fe²⁺);
(ii) in an operational cycle, electrolysing the feedstock electrolyte to produce an anolyte solution comprising peroxydisulphate (S₂O₈²⁻) and ferric ions (Fe³⁺); and
(iii) supplying said anolyte solution from the anodic half-cell.

7. The method for generation of an oxidant solution according to claim 6 wherein a separator is located between the anodic half-cell and cathodic half-cell.

8. The method for generation of an oxidant solution using an electrochemical cell according to claim 1 including the further steps of regenerating the oxidant solution by:
(iii) supplying said oxidised acid solution to a metal containing waste, such that the ferric ions (Fe³⁺) are reduced to ferrous ions (Fe²⁺); and
(iv) bringing peroxydisulphate (S₂O₈²⁻) into contact with the ferrous ions (Fe²⁺) to regenerate ferric ions (Fe³⁺) and sulphate ions (SO₄²⁻).

9. A system, for generation of an oxidant solution according to the method of claim 1, comprising:
(a) an anode and a cathode defining a reaction area of an electrochemical cell,
(b) an input port and flow controller for passage of aqueous feedstock electrolyte through between the electrodes, the feedstock electrolyte consisting of sulphate ions (SO₄²⁻) and ferrous ions (Fe²⁺), the sulphate ions and ferrous ions being selected for electrochemical generation of an oxidant comprising peroxydisulphate (S₂O₈²⁻) and ferric ions (Fe³⁺);
(c) current means for supplying current for electrolysing the aqueous feedstock electrolyte to produce an oxidant solution in the reaction area containing said oxidant, and
(d) an output port for supplying the oxidant solution from the electrochemical cell.

10. A system, for on-site generation of an oxidant solution according to the method of claim 1, comprising:
(a) an anodic half-cell and a cathodic half-cell,
(b) an input port and flow control means for passage of aqueous feedstock electrolyte through the anodic half-cell, the feedstock electrolyte consisting of sulphate ions (SO₄²⁻) and ferrous ions (Fe²⁺), the sulphate ions and ferrous ions being selected for electrochemical generation of an oxidant comprising peroxydisulphate (S₂O₈²⁻) and ferric ions (Fe³⁺);
(c) current means for supplying current for electrolysing the aqueous feedstock electrolyte to produce an oxidant solution in the anodic half-cell containing said oxidant, and
(d) an output port for supplying the oxidant solution from the electrochemical cell from the anodic half-cell.

11. The system for generation of an oxidant solution according to claim 10 wherein a separator is located between the anodic half-cell and the cathodic half-cell.

12. The system according to claim 9 wherein the oxidant solution is used for metal extraction.

13. The system according to claim 12 wherein the metal is extracted from e-waste or minerals.

14. The method of leaching metal from metal containing waste, the method including the step of supplying the oxidant solution generated by the method of claim 1, and bringing the oxidant solution into contact with the metal containing waste.

15. The A method of leaching metal according to claim 14, wherein the metal leached is chosen from the group comprising Cu, Co, Ni, V, Cr, Mn and Fe.

16. The system according to claim 12 wherein the oxidant solution is used for extraction of one or more metals chosen from the group comprising Cu, Co, Ni, V, Cr, Mn, Fe, Au, Ag, Pt, Pd, Rh, Ir, Ru, Te, Ga, Se, Ta, Ge Pb, Cd, In and Sb.
